(19) United States
(12) Patent Application Publication
(10) Pub. No.: US 2024/0402477 A1
(43) Pub. Date: Dec. 5, 2024

(54) MULTISCALE LENS SYSTEMS AND METHODS FOR IMAGING WELL PLATES AND INCLUDING EVENT-BASED DETECTION

(71) Applicant: PLENO, INC., San Diego, CA (US)

(72) Inventors: Pavel SHEKHTMEYSTER, San Diego, CA (US); Bojan OBRADOVIC, San Diego, CA (US); Ludovic VINCENT, San Diego, CA (US); Pieter VAN ROOYEN, San Diego, CA (US)

(21) Appl. No.: 18/800,619

(22) Filed: Aug. 12, 2024

Related U.S. Application Data
(63) Continuation of application No. PCT/US2023/062536, filed on Feb. 14, 2023.
(60) Provisional application No. 63/310,514, filed on Feb. 15, 2022.
(60) Provisional application No. 63/480,574, filed on Jan. 19, 2023.

(51) Int. Cl. G02B 21/08; G01N 21/64; G02B 21/16; G02B 21/36

(52) U.S. Cl. CPC G02B 21/086; G01N 21/6486; G02B 21/16; G02B 21/36; G01N 2201/0407; G01N 2201/0446; G01N 2201/062

(57) ABSTRACT

Multiscale lens systems and methods for imaging well plates and including event-based detection is disclosed. In some embodiments, the multiscale lens systems and methods provide a multiple read-head optical detection system, a step-and-shoot optical detection system, a multiscale microlens optical detection system, and/or a multiscale GRIN lens optical detection system. Further, a fluidics system may include a liquid handling system and a multiscale optical detection system in relation to a well plate. Further, a method of using a multiple read-head optical detection system is provided. Further, a method of using a step-and-shoot optical detection system is provided. Further, a method of using a lens array optical detection system is provided.

### RELATED APPLICATIONS

This application is a continuation application of International Application No. PCT/US2023/062536, filed Feb. 14, 2023, which claims the benefit of U.S. Provisional Application No. 63/310,514, filed on Feb. 15, 2022, and U.S. Provisional Application No. 63/480,574, filed on Jan. 19, 2023, each of which is herein incorporated by reference in its entirety.

### TECHNICAL FIELD

The subject matter relates generally to optical detection systems for processing biological materials and more particularly to multiscale lens systems and methods for imaging well plates and including event-based detection.

### BACKGROUND

Optical detection systems are used for processing biological materials in well plates. Examples of well plates include, but are not limited to, 6-well, 12-well, 24-well, 48-well, 96-well, 384-well, and 1536-well microplates. Currently, existing optical detection processes scan from well to well or from one position to another position and take images with a camera. Accordingly, existing optical detection systems can be complex because they require moving parts. Further, current optical detection processes are slow because the well plates are imaged and processed one well at a time. For example, if it takes about one second to image and process one well, it may take up to about 384 seconds (more than 6 minutes) to perform optical detection on a 384-well microplate. Therefore, new approaches are needed with respect to simplifying optical detection systems and/or speeding up the optical detection process for well plates.

### SUMMARY

Aspects of the disclosure provided herein comprise a system configured to image a surface, comprising: a first light source and a second light source configured to illuminate a first surface of a well, wherein the first light source is separated at a distance of less than about 500 nanometers from the second light source: an optical element configured to couple emitted light of the first light source and the second light source from a second surface of the well, wherein the second surface of the well is axially separated from the first surface of the first well along an optical axis parallel to an optical axis of the first light source and the second light source, and wherein the optical element comprises a plurality of lens elements; and a detector optically coupled to the optical element, wherein the detector is configured to detect the light emitted from the second surface of the well. In some embodiments, the optical element further comprises a polygonal optical element coupled to a surface of at least a lens of the plurality of lens elements. In some embodiments, the first light source and the second light source comprise a light emitting diode. In some embodiments, the light emitting diode comprises a plurality of light emitting diodes. In some embodiments, the light emitting diode comprises an array of light emitting diodes. In some embodiments, the well comprises a well of a multi-well plate. In some embodiments, the detector comprises a plurality of detectors, wherein a first detector of the plurality of detectors is configured to detect emitted light from a first well of the multi-well plate, and a second detector of the plurality of detectors is configured to detect light from a second well of the multi-well plate. In some embodiments, the first well and the second well are non-adjacent wells of the multi-well plate. In some embodiments, the first light source emits a first wavelength of light, and the second light source emits a second wavelength of light, wherein the first wavelength of light and the second wavelength of light differ.

Aspects of the disclosure provided herein comprise a system configured to image a surface, comprising: a first light source and a second light source configured to illuminate a first surface of a well, wherein the first light source is positioned at a distance of less than about the diffraction limit of the second light source: an optical element configured to couple emitted light of the first light source and the second light source from a second surface of the well, wherein the second surface of the well is axially separated from the first surface of the first well along an optical axis parallel to an optical axis of the first light source and the second light source, and wherein the optical element comprises a plurality of lens elements; and a detector optically coupled to the optical element, wherein the detector is configured to detect the light emitted from the second surface of the well. In some embodiments, the optical element further comprises a polygonal optical element coupled to a surface of at least a lens of the plurality of lens elements. In some embodiments, the first light source and the second light source comprise a light emitting diode. In some embodiments, the light emitting diode comprises a plurality of light emitting diodes. In some embodiments, the light emitting diode comprises an array of light emitting diodes. In some embodiments, the well is a well of a multi-well plate. In some embodiments, the detector comprises a plurality of detectors, wherein a first detector of the plurality of detectors is configured to detect emitted light from a first well of the multi-well plate, and a second detector of the plurality of detectors is configured to detect light from a second well of the multi-well plate. In some embodiments, the first well and the second well are non-adjacent wells of the multi-well plate. In some embodiments, the first light source emits a first wavelength of light and the second light source emits a second wavelength of light, wherein the first wavelength of light and the second wavelength of light differ.

Aspects of the disclosure provided herein comprise a system configured to image a surface, comprising: a first light source and a second light source configured to illuminate a first surface of a well: an optical element configured to couple emitted light of the first light source and the second light source from a second surface of the well, wherein the second surface of the well is axially separated from the first surface of the first well along an optical axis parallel to an optical axis of the first light source and the second light source, wherein the optical element comprises a first optical element and a second optical element separated by a center-to-center spacing of at least 100 nanometers; and a detector optically coupled to the optical element, wherein the detector is configured to detect the light emitted from the second surface of the well. In some embodiments, first optical element and the second optical element are lens elements. In some embodiments, the optical element comprises a plurality of lens elements. In some embodiments, the optical element further comprises a polygonal optical element coupled to a surface of at least a lens of the plurality of lens elements. In some embodiments, the first light source and the second light source comprise a light emitting diode. In some embodiments, the light emitting diode comprises a plurality of light emitting diodes. In some embodiments, the light emitting diode comprises an array of light emitting diodes. In some embodiments, the well is a well of a multi-well plate. In some embodiments, the detector comprises a plurality of detectors, wherein a first detector of the plurality of detectors is configured to detect emitted light from a first well of the multi-well plate, and a second detector of the plurality of detectors is configured to detect light from a second well of the multi-well plate. In some embodiments, the first well and the second well are non-adjacent wells of the multi-well plate. In some embodiments, the first light source emits a first wavelength of light and the second light source emits a second wavelength of light, wherein the first wavelength of light and the second wavelength of light differ.

Aspects of the disclosure provided comprise a system configured to image a surface, comprising: a first light source and a second light source configured to illuminate a first surface of a well: an optical element configured to couple emitted light of the first light source and the second light source from a second surface of the well, wherein the second surface of the well is axially separated from the first surface of the first well along an optical axis parallel to an optical axis of the first light source and the second light source, wherein the optical element comprises a first optical element and a second optical element which are separated by a distance of less than about the diffraction limit of light emitted by the first light source or the second light source; and a detector optically coupled to the optical element, wherein the detector is configured to detect the light emitted from the second surface of the well. In some embodiments, the first optical element and the second optical element are lens elements. In some embodiments, the optical element comprises a plurality of lens elements. In some embodiments, the optical element further comprises a polygonal optical element coupled to a surface of at least a lens of the plurality of lens elements. In some embodiments, the first light source and the second light source comprise a light emitting diode. In some embodiments, the light emitting diode comprises a plurality of light emitting diodes. In some embodiments, the light emitting diode comprises an array of light emitting diodes. In some embodiments, the well is a well of a multi-well plate. In some embodiments, the detector comprises a plurality of detectors, wherein a first detector of the plurality of detectors is configured to detect emitted light from a first well of the multi-well plate, and a second detector of the plurality of detectors is configured to detect light from a second well of the multi-well plate. In some embodiments, the first well and the second well are non-adjacent wells of the multi-well plate. In some embodiments, the first light source emits a first wavelength of light and the second light source emits a second wavelength of light, wherein the first wavelength of light and the second wavelength of light differ.

Aspects of the disclosure provided comprise a method, comprising: illuminating a first surface of a well with a first light source and a second light source, wherein the first light source is separated by at least about 500 nm from the second light source; and detecting light emitted from a second surface of the well through an optical element optically coupled to the second surface, wherein the second surface of the well is axially separated from the first surface of the well along an optical axis parallel to the first light source and the second light source. In some embodiments, the light emitted from the second surface is detected by a detector. In some embodiments, the detector comprises a plurality of detectors. In some embodiments, the detector comprises a two-dimensional sensor. In some embodiments, the detector comprises a charge coupled device sensor or a complementary metal oxide semiconductor sensor. In some embodiments, the well comprises a well of a multi-well plate. In some embodiments, the method further comprises translating the detector, first light source, and second light source along an axis of the multi-well plate and repeating (a) and (b). In some embodiments, the optical element comprises a first optical element and a second optical element. In some embodiments, the first optical element and the second optical element are lens elements. In some embodiments, the optical element comprises a plurality of lens elements. In some embodiments, the optical element further comprises a polygonal optical element coupled to a surface of at least a lens of the plurality of lens elements. In some embodiments, the first light source and the second light source comprise a light emitting diode. In some embodiments, the light emitting diode comprises a plurality of light emitting diodes. In some embodiments, the light emitting diode comprises an array of light emitting diodes. In some embodiments, the detector comprises a plurality of detectors, wherein a first detector of the plurality of detectors is configured to detect emitted light from a first well of the multi-well plate, and a second detector of the plurality of detectors is configured to detect light from a second well of the multi-well plate. In some embodiments, the first well and the second well are non-adjacent wells of the multi-well plate. In some embodiments, the first light source emits a first wavelength of light and the second light source emits a second wavelength of light, wherein the first wavelength of light and the second wavelength of light differ.

Aspects of the disclosure provided comprise a method, comprising: illuminating a first surface of a well with a first light source and a second light source, wherein the first light source is separated by at least about the diffraction limit of the first light source or the second light source; and detecting light emitted from a second surface of the well through an optical element optically coupled to the second surface, wherein the second surface of the well is axially separated from the first surface of the well along an optical axis parallel to the first light source and the second light source. In some embodiments, the light emitted from the second surface is detected by a detector. In some embodiments, the detector comprises a plurality of detectors. In some embodiments, the detector comprises a two-dimensional sensor. In some embodiments, the detector comprises a charge coupled device sensor or a complementary metal oxide semiconductor sensor. In some embodiments, the well comprises a well of a multi-well plate. In some embodiments, the method further comprises translating the detector, first light source, and second light source along an axis of the multi-well plate and repeating (a) and (b). In some embodiments, the optical element comprises a first optical element and a second optical element. In some embodiments, the first optical element and the second optical element are lens elements. In some embodiments, the optical element comprises a plurality of lens elements. In some embodiments, the optical element further comprises a polygonal optical element coupled to a surface of at least a lens of the plurality of lens elements. In some embodiments, the first light source and the second light source comprise a light emitting diode. In some embodiments, the light emitting diode comprises a plurality of light emitting diodes. In some embodiments, the light emitting diode comprises an array of light emitting diodes. In some embodiments, the detector comprises a plurality of detectors, wherein a first detector of the plurality of detectors is configured to detect emitted light from a first well of the multi-well plate, and a second detector of the plurality of detectors is configured to detect light from a second well of the multi-well plate. In some embodiments, the first well and the second well are non-adjacent wells of the multi-well plate. In some embodiments, the first light source emits a first wavelength of light and the second light source emits a second wavelength of light, wherein the first wavelength of light and the second wavelength of light differ.

Aspects of the disclosure provide comprise a method, comprising: illuminating a first surface of a well with a first light source and a second light source, wherein the; and detecting light emitted from a second surface of the well through an optical element optically coupled to the second surface, wherein the second surface of the well is axially separated from the first surface of the well along an optical axis parallel to the first light source and the second light source, and wherein the optical element comprises a first optical element and a second optical element separated by a distance of at least about 100 nanometers. In some embodiments, the light emitted from the second surface is detected by a detector. In some embodiments, the detector comprises a plurality of detectors. In some embodiments, the detector comprises a two-dimensional sensor. In some embodiments, the detector comprises a charge coupled device sensor or a complementary metal oxide semiconductor sensor. In some embodiments, the well comprises a well of a multi-well plate. In some embodiments, the method further comprises translating the detector, first light source, and second light source along an axis of the multi-well plate and repeating (a) and (b). In some embodiments, the first optical element and the second optical element are lens elements. In some embodiments, the optical element comprises a plurality of lens elements. In some embodiments, the optical element further comprises a polygonal optical element coupled to a surface of at least a lens of the plurality of lens elements. In some embodiments, the first light source and the second light source comprise a light emitting diode. In some embodiments, the light emitting diode comprises a plurality of light emitting diodes. In some embodiments, the light emitting diode comprises an array of light emitting diodes. In some embodiments, the detector comprises a plurality of detectors, wherein a first detector of the plurality of detectors is configured to detect emitted light from a first well of the multi-well plate, and a second detector of the plurality of detectors is configured to detect light from a second well of the multi-well plate. In some embodiments, the first well and the second well are non-adjacent wells of the multi-well plate. In some embodiments, the first light source emits a first wavelength of light and the second light source emits a second wavelength of light, wherein the first wavelength of light and the second wavelength of light differ.

Aspects of the disclosure provided comprise a method, comprising: illuminating a surface of a well with a light source, wherein the surface of the well comprises at least a first analyte and a second analyte disposed adjacent to the surface, wherein the first analyte and the second analyte are separated by a distance of less than about the diffraction limit of light of a first emission of the first analyte or the diffraction limit of light of a second emission of the second analyte emitted when illuminated by the light source; and detecting at least a signal of the first emission and of the second emission from the surface of the well through an optical element optically coupled to the surface, wherein the optical element comprises at least a first optical element and a second optical element separated by a distance of less than about the diffraction limit of the light of the first emission or the light of the second emission. In some embodiments, the light of the first emission and the second emission are detected by a detector. In some embodiments, the detector comprises a plurality of detectors. In some embodiments, the detector comprises a two-dimensional sensor. In some embodiments, the detector comprises a charge coupled device sensor or a complementary metal oxide semiconductor sensor. In some embodiments, the well comprises a well of a multi-well plate. In some embodiments, the method further comprises translating the detector, light source, and optical element along an axis of the multi-well plate and repeating (a) and (b). In some embodiments, the first optical element and the second optical element are lens elements. In some embodiments, the optical element comprises a plurality of lens elements. In some embodiments, the optical element further comprises a polygonal optical element coupled to a surface of at least a lens of the plurality of lens elements. In some embodiments, the light source comprises a light emitting diode. In some embodiments, the light emitting diode comprises a plurality of light emitting diodes. In some embodiments, the light emitting diode comprises an array of light emitting diodes. In some embodiments, the detector comprises a plurality of detectors, wherein a first detector of the plurality of detectors is configured to detect a signal of light from a first well of the multi-well plate, and a second detector of the plurality of detectors configured to detect a signal of light from a second well of the multi-well plate. In some embodiments, the first well and the second well are non-adjacent wells of the multi-well plate. In some embodiments, the light source emits a first wavelength of light and a second wavelength of light, wherein the first wavelength of light and the second wavelength of light differ.

Aspects of the disclosure provided comprise a system configured to image a surface, comprising: a light source configured to illuminate at least a first surface of a first well and a first surface of a second well of a multi-well plate, wherein the first well and the second well are nonadjacent wells: a first optical element configured to transmit emitted light of a second surface of the first well and a second surface of the second well to an imaging plane of a second optical element, wherein the first optical element comprises a plurality of lens elements, wherein the first surface of the first well is axially separated from the second surface of the first well along an optical axis of the light source, and wherein the first surface of the second well is axially separated from the second surface of the second well along the optical axis of the light source; and a detector optically coupled to the second optical element, wherein the detector is configured to detect the emitted light of the second surface of the first well and the second surface of the second well. In some embodiments, the plurality of lens elements of the first optical element further comprises a polygonal optical element coupled to a surface of at least a lens of the plurality of lens elements. In some embodiments, the plurality of lens elements comprise at least a first lens element configured to transmit emitted light of the second surface of the first well to the imaging plane of the second optical element, and a second lens element configured to transmit emitted light of the second surface of the second well to the imaging plane of the second optical element. In some embodiments, the light source comprises a light emitting diode. In some embodiments, the light emitting diode comprises a plurality of light emitting diodes. In some embodiments, the light emitting diode comprises an array of light emitting diodes. In some embodiments, the detector comprises a plurality of detectors, wherein a first detector of the plurality of detectors is configured to detect emitted light from a first area of the well plate, wherein a second detector of the plurality of detectors is configured to detect emitted light from a second area of the well plate, and wherein the first area of the well plate and the second area of the well plate do not overlap. In some embodiments, the detector comprises a two-dimensional sensor. In some embodiments, the detector comprises a charge coupled device sensor or a complementary metal oxide semiconductor sensor. In some embodiments, the light source comprises a first light source configured to illuminate the first surface of the first well and a second light source configured to illuminate the second surface of the second well. In some embodiments, the first light source and the second light source emit wavelengths or wavelength bands of light that differ. In some embodiments, the second optical element comprises a plurality of optical elements. In some embodiments, the second optical element comprises an aspheric doublet, a positive focal length lens, a negative focal length lens, a plano-convex lens, a plano-concave lens, a convex lens, a bi-convex lens, a concave lens, a bi-concave lens, or any combination thereof.

Aspects of the disclosure provided comprise a method, comprising: providing a multi-well plate, wherein the multi-well plate comprises a plurality of wells: illuminating at least a first surface of a first well and a first surface of a second well of the plurality of wells, wherein the first well and the second well are not adjacent; and detecting light emitted from a second surface of the first well and a second surface of the second well through an optical element, wherein the first surface of the first well is axially separated from the second surface of the first well along an optical axis of the light emitted, and wherein the first surface of the second well is axially separated from the second surface of the second well along the optical axis of the light emitted. In some embodiments, the light emitted from the second surface of the first well and the second surface of the second well is detected by a detector. In some embodiments, the detector comprises a plurality of detectors. In some embodiments, the method further comprises translating the detector along an axis of the multi-well plate and repeating (b) and (c). In some embodiments, the detector comprises a two-dimensional sensor. In some embodiments, the detector comprises a charge coupled device sensor or a complementary metal oxide semiconductor sensor. In some embodiments, the optical element comprises at least a first optical element and a second optical element, wherein the first optical element is configured to detect light emitted from the second surface of the first well, and wherein the second optical element is configured to detect light emitted from the second surface of the second well. In some embodiments, the optical element comprises a plurality of lens elements. In some embodiments, the plurality of lens elements further comprises a polygonal optical element coupled to a surface of at least a lens of the plurality of lens elements. In some embodiments, the optical element comprises a micro-lens array. In some embodiments, the optical element comprises a plurality of gradient index of refraction (GRIN) lenses. In some embodiments, the first surface of the first well and the first surface of the second well are illuminated by a light source. In some embodiments, the light source comprises a light emitting diode. In some embodiments, the light source comprises a plurality of light emitting diodes. In some embodiments, the light source comprises an array of light emitting diodes. In some embodiments, the light source comprises a first light source configured to illuminate the first surface of the first well and a second light source configured to illuminate the first surface of the second well. In some embodiments, the first light source emits a first wavelength or first wavelength band, wherein the second light source emits a second wavelength or second wavelength band, and wherein the first wavelength or first wavelength band differs from the second wavelength or second wavelength band.

### BRIEF DESCRIPTION OF DRAWINGS

Having thus described the subject matter in general terms, reference will now be made to the accompanying drawings, which are not necessarily drawn to scale, and wherein:

FIG. 1 illustrates a perspective view of an example of a six read-head optical detection system in relation to a well plate for processing biological materials, in accordance with an embodiment of the disclosure:

FIG. 2A illustrates a plan view of an example of the fields-of-view of the six read-head optical detection system shown in FIG. 1 in relation to a 384-well microplate:

FIG. 2B illustrates a plan view of an example of the fields-of-view of the six read-head optical detection system shown in FIG. 1 in relation to a 384-well microplate:

FIG. 2C illustrates a plan view of an example of the fields-of-view of the six read-head optical detection system shown in FIG. 1 in relation to a 384-well microplate:

FIG. 3 illustrates a side view of an example of one configuration of the six read-head optical detection system shown in FIG. 1:

FIG. 4 illustrates a side view of an example of one configuration of the six read-head optical detection system shown in FIG. 1:

FIG. 5 illustrates a side view of an example of one configuration of the six read-head optical detection system shown in FIG. 1:

FIG. 6 illustrates a side view of an example of another configuration of the six read-head optical detection system shown in FIG. 1;

FIG. 7 illustrates a side view of an example of yet another configuration of the six read-head optical detection system shown in FIG. 1;

FIG. 8 illustrates a perspective view of an example of still another configuration of the six read-head optical detection system shown in FIG. 1:

FIG. 9 illustrates a plan view of an example of the fields-of-view of the six read-head optical detection system shown in FIG. 8 in relation to a 384-well microplate;

FIG. 10 illustrates a side view showing more details of a large-scale compound lens of the six read-head optical detection system shown in FIG. 8 and FIG. 9;

FIG. 11A illustrates an example of a spot diagram of the large-scale compound lens of the six read-head optical detection system shown in FIG. 8 and FIG. 9:

FIG. 11B illustrates an example of a spot diagram of the large-scale compound lens of the six read-head optical detection system shown in FIG. 8 and FIG. 9;

FIG. 11C illustrates an example of a spot diagram of the large-scale compound lens of the six read-head optical detection system shown in FIG. 8 and FIG. 9;

FIG. 11D illustrates an example of a spot diagram of the large-scale compound lens of the six read-head optical detection system shown in FIG. 8 and FIG. 9;

FIG. 12 illustrates a table indicating an example of the read-head prescription of the six read-head optical detection system shown in FIG. 8 and FIG. 9;

FIG. 13 illustrates a side view of an example of a step-and-shoot optical detection system, in accordance with an embodiment of the disclosure:

FIG. 14A illustrates a plan view of an example of the field-of-view of a 6-step step-and-shoot optical detection system in relation to a 384-well microplate:

FIG. 14B illustrates a plan view of an example of the field-of-view of a 6-step step-and-shoot optical detection system in relation to a 384-well microplate:

FIG. 14C illustrates a plan view of an example of the field-of-view of a 6-step step-and-shoot optical detection system in relation to a 384-well microplate:

FIG. 15 illustrates a side view of another example of a step-and-shoot optical detection system, in accordance with an embodiment of the disclosure:

FIG. 16A illustrates a plan view of an example of the field-of-view of a 24-step step-and-shoot optical detection system in relation to a 384-well microplate:

FIG. 16B illustrates a plan view of an example of the field-of-view of a 24-step step-and-shoot optical detection system in relation to a 384-well microplate:

FIG. 16C illustrates a plan view of an example of the field-of-view of a 24-step step-and-shoot optical detection system in relation to a 384-well microplate:

FIG. 17 illustrates a perspective view of an example of a multiscale microlens optical detection system in relation to a well plate for processing biological materials, in accordance with an embodiment of the disclosure:

FIG. 18A illustrates a side view of a portion of the multiscale microlens optical detection system shown in FIG. 17 and a process of using same:

FIG. 18B illustrates a side view of a portion of the multiscale microlens optical detection system shown in FIG. 17 and a process of using same:

FIG. 18C illustrates a side view of a portion of the multiscale microlens optical detection system shown in FIG. 17 and a process of using same:

FIG. 19 illustrates a side view of another configuration of the multiscale microlens optical detection system shown in FIG. 17:

FIG. 20 illustrates a perspective view of an example of a multiscale GRIN lens optical detection system in relation to a well plate for processing biological materials, in accordance with an embodiment of the disclosure:

FIG. 21 illustrates a side view of a portion of the multiscale GRIN lens optical detection system shown in FIG. 20;

FIG. 22 illustrates a perspective view and a side view of an example of a GRIN lens that may be used in the multiscale GRIN lens optical detection system shown in FIG. 20:

FIG. 23 illustrates a block diagram of an example of a fluidics system that may be based on the optical detection configurations and/or systems shown in FIG. 1 through FIG. 22 and that may further include event-based detection:

FIG. 24 illustrates a flow diagram of an example of a method of using the fluidics system shown in FIG. 23 that includes a multiple read-head optical detection system:

FIG. 25 illustrates a flow diagram of an example of a method of using the fluidics system shown in FIG. 23 that includes a step-and-shoot optical detection system:

FIG. 26 illustrates a flow diagram of an example of a method of using the fluidics system shown in FIG. 23 that includes a lens array optical detection system:

FIG. 27 illustrates a side view of a configuration of the multiscale GRIN microlens optical detection system configured to image a surface of a well of a multi well plate at less than the diffraction limit of light emitted by biological material adjacent and/or coupled to the well plate surface, in accordance with an embodiment of the disclosure:

FIG. 28 illustrates a side view of a configuration of the multiscale microlens optical detection system configured to image a surface of a well of a multi well plate at less than the diffraction limit of light emitted by biological material adjacent and/or coupled to the well plate surface, in accordance with an embodiment of the disclosure:

FIG. 29 illustrates a side view of an example of a multiscale microlens step-and-shoot optical detection system configured to image a surface of a well of a multi well plate at less than the diffraction limit of light emitted by biological materials adjacent and/or coupled to the well plate surface, in accordance with an embodiment of the disclosure; and

FIG. 30 illustrates a side view of an example of a multiscale GRIN microlens step-and-shoot optical detection system configured to image a surface of a well of a multi well plate at less than the diffraction limit of light emitted by biological materials adjacent and/or coupled to the well plate surface, in accordance with an embodiment of the disclosure.

### DETAILED DESCRIPTION

The subject matter now will be described more fully hereinafter with reference to the accompanying drawings, in which some, but not all embodiments of the subject matter are shown. Like numbers refer to like elements throughout. The subject matter may be embodied in many different forms and should not be construed as limited to the embodiments set forth herein: rather, these embodiments are provided so that this disclosure will satisfy applicable legal requirements. Indeed, many modifications and other embodiments of the subject matter set forth herein will come to mind to one skilled in the art to which the subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims.

In some embodiments, the subject matter provides multiscale lens systems and methods for imaging well plates and including event-based detection. Further, a fluidics system is provided that may include at least one of the multiscale lens systems and a liquid handling system in relation to, for example, a multi-well microplate.

In some embodiments, the multiscale lens systems and methods provide an optical detection system including one or more read heads (e.g., cameras) that are stationary and accordingly an optical detection system is provided that includes no moving parts.

In some embodiments, the multiscale lens systems and methods provide an optical detection system including one or more read heads (e.g., cameras) that may be moved (or stepped) in two dimensions and accordingly an optical detection system is provided that may include certain moving parts, such as a camera system mounted on a linear translator (e.g., linear X-Y stage).

In some embodiments, the multiscale lens systems and methods provide a six read-head optical detection system to perform high resolution fluorescence imaging of all wells of a well plate, such as, but not limited to, all wells of a 384-well microplate.

In some embodiments, the multiscale lens systems and methods provide a six read-head optical detection system and wherein the combined fields-of-view (FOV) of six stationary read heads (e.g., cameras) may be used to image a well plate substantially in its entirety.

In some embodiments, the multiscale lens systems and methods provide a six read-head optical detection system for imaging an entire well plate using a single image capture operation at each of the six stationary read heads (e.g., cameras) and then processing the six images to analyze the biological materials present in each individual well of the well plate. In some embodiments, the biological materials may comprise one or more analytes, cells, nucleic acid molecules, proteins, peptides, beads, or any combination thereof.

In some embodiments, the multiscale lens systems and methods provide a step-and-shoot optical detection system to perform high resolution fluorescence imaging of all wells of a well plate, such as, but not limited to, all wells of a 384-well microplate.

In some embodiments, the multiscale lens systems and methods provide a 6-step step-and-shoot optical detection system and wherein a single read head (e.g., camera) may be stepped in X-Y to sequentially image a one-sixth portion of a well plate.

In some embodiments, the multiscale lens systems and methods provide a 24-step step-and-shoot optical detection system and wherein a single read head (e.g., camera) may be stepped in X-Y to sequentially image a one-twenty-fourth portion of a well plate.

In some embodiments, the multiscale lens systems and methods provide a step-and-shoot optical detection system and wherein a single read head (e.g., camera) may be stepped in X-Y to sequentially image portions of a well plate and wherein each image may be processed and analyzed with respect to determining the biological materials present in each individual well of the well plate.

In some embodiments, the multiscale lens systems and methods provide a multiscale lens array optical detection system to perform high resolution fluorescence imaging of all wells of a well plate, such as, but not limited to, all wells of a 384-well microplate.

In some embodiments, the multiscale lens systems and methods provide a multiscale microlens optical detection system including a microlens array, a controllable light source array, and a stationary read head (e.g., camera), all in relation to a well plate.

In some embodiments, the multiscale lens systems and methods provide a multiscale microlens optical detection system including an array of microlenses and a large-scale compound lens and wherein each of the microlenses and the large-scale compound lens work independently.

In some embodiments, the multiscale lens systems and methods provide a multiscale microlens optical detection system including an array of microlenses and a large-scale compound lens and thereby providing a way to have both a large numerical aperture (NA) and a large field-of-view (FOV).

In some embodiments, the multiscale lens systems and methods provide a multiscale gradient-index (GRIN) lens optical detection system including a GRIN lens array, a controllable light source array, and a stationary read head (e.g., camera), all in relation to a well plate.

In some embodiments, the multiscale lens systems and methods provide a multiscale GRIN lens optical detection system including an array of GRIN lenses and a large-scale compound lens and wherein each of the GRIN lenses and the large-scale compound lens work independently.

In some embodiments, the multiscale lens systems and methods provide a multiscale GRIN lens optical detection system including an array of GRIN lenses and a large-scale compound lens and thereby providing a way to have both a large numerical aperture (NA) and a large field-of-view (FOV).

In some embodiments, the multiscale lens systems and methods provide a fluidics system that may include a six read-head optical detection system or a step-and-shoot optical detection system or a multiscale microlens optical detection system or a multiscale GRIN lens optical detection system and a liquid handling system in relation to a well plate.

In some embodiments, the multiscale lens systems and methods provide a fluidics system that may include a six read-head optical detection system or a step-and-shoot optical detection system or a multiscale microlens optical detection system or a multiscale GRIN lens optical detection system and wherein the optical detection systems may further include event-based sensors.

In some embodiments, the multiscale lens systems and methods provide a fluidics system that may include a six read-head optical detection system or a step-and-shoot optical detection system or a multiscale microlens optical detection system or a multiscale GRIN lens optical detection system, a controller, and an image processing module or algorithm.

Further, a method of using a fluidics system including a multiple read-head optical detection system is provided.

Further, a method of using a fluidics system including a step-and-shoot optical detection system is provided.

Further, a method of using a fluidics system including a lens array optical detection system is provided.

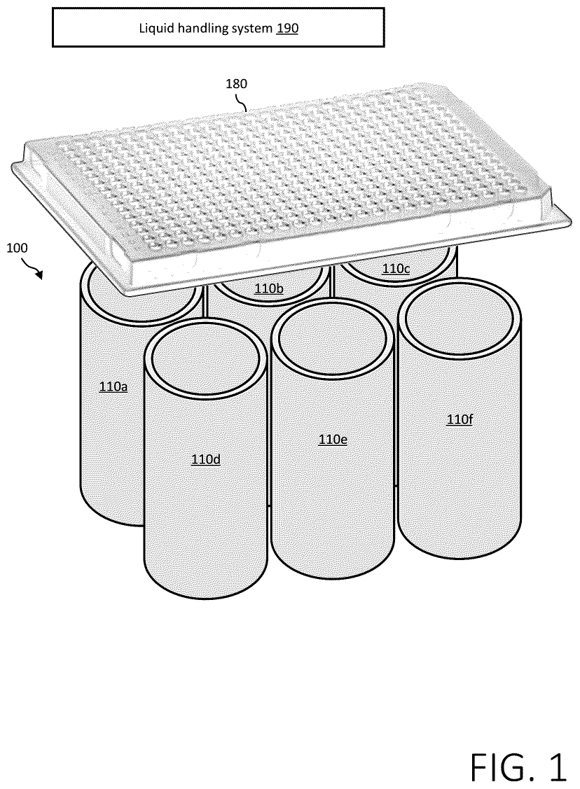

Referring now to FIG. 1 is a perspective view of an example of a six read-head optical detection system 100 in relation to a well plate 180 for processing biological materials, in accordance with an embodiment of the disclosure.

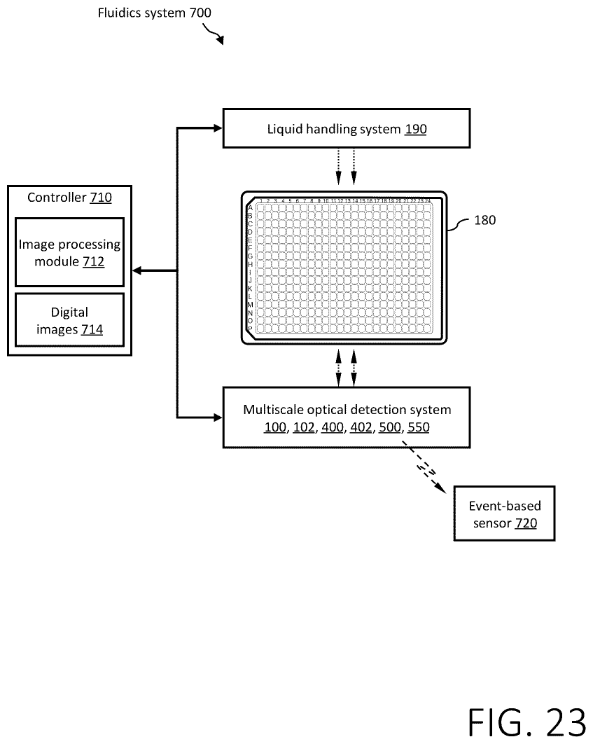

Further, a liquid handling system 190 may be provided in relation to well plate 180. Liquid handling system 190 may be, for example, an automated liquid handling system. In this example, six read-head optical detection system 100 may be provided beneath well plate 180 and liquid handling system 190 may be provided above well plate 180. Well plate 180 may be any standard glass or plastic well plate used for processing biological materials and that is substantially transparent to light. Well plate 180 may be, for example, a standard 6-well, 12-well, 24-well, 48-well, 96-well, 384-well, or 1536-well microplate. In the example shown in FIG. 1, well plate 180 is a 384-well microplate. Together, six read-head optical detection system 100, well plate 180, and liquid handling system 190 may form a fluidics system (see FIG. 23).

### Multiple Read-Head Optical Detection

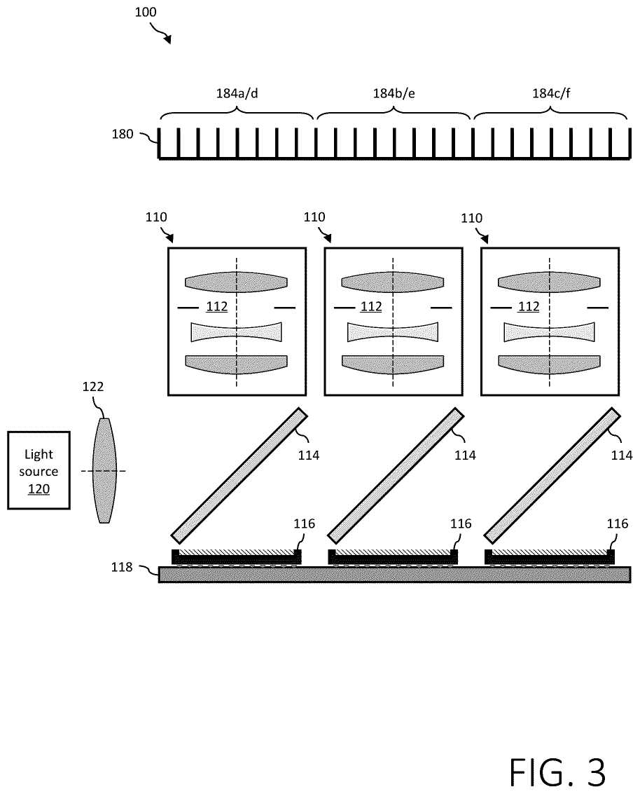

Six read-head optical detection system 100 may include six camera systems 110. For example, six read-head optical detection system 100 may include camera systems 110a, 110b, 110c, 110d, 110e, and 110f arranged in a 2×3 configuration. Each of the camera systems 110 may be capable of performing high resolution fluorescence imaging. For example, each of the camera systems 110 may include a large-scale compound lens, an image sensor, and a light source among other optical components. Generally, each of the camera systems 110 may include any arrangements of optical components, such as, but not limited to, optical lenses, optical filters, mirrors, prisms, polarizers, gratings, and the like. More details of example configurations of camera systems 110 are shown and described below with reference to FIG. 3 through FIG. 12.

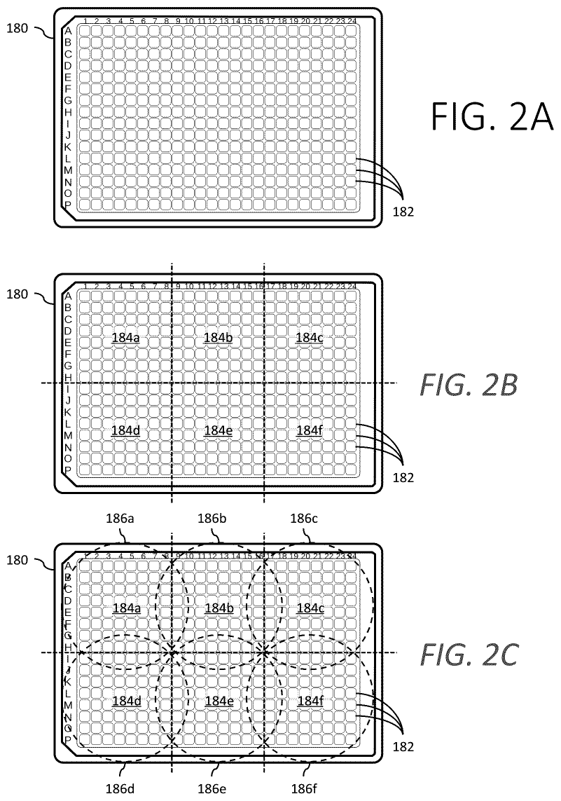

Each of the camera systems 110 of six read-head optical detection system 100 has a certain field-of-view (FOV). Together, the combined fields-of-view (FOVs) of the six camera systems 110 may capture the full area of well plate 180 with all its wells (e.g., 384 wells). For example, FIG. 2A, FIG. 2B, and FIG. 2C is plan views of an example of the FOVs of six read-head optical detection system 100 in relation to a well plate 180. In this example, well plate 180 is more specifically called a 384-well microplate 180.

FIG. 2A shows a plan view of an example of 384-well microplate 180 that includes a 16×24 arrangement of wells 182. The overall dimensions of 384-well microplate 180 may be about 127.6 mm×85.6 mm (e.g., a standard wall plate dimensions). Further, the overall dimensions of the well area may be about 103.50 mm×67.50 mm. In the case of 384-well microplate 180, each individual well 182 may be about 3.65 mm×3.65 mm.

FIG. 2B shows the well area of 384-well microplate 180 may be divided into eight plate segments 184. In this example, each plate segment 184 may include an 8×8 arrangement of wells 182. For example, plate segments 184a, 184b, 184c, 184d, 184e, and 184f. Accordingly, each of the plate segments 184 includes a different 64 wells 182 out of the 384 wells 182.

In six read-head optical detection system 100, each of the camera systems 110 corresponds to one of the plate segments 184 of 384-well microplate 180. Further, FIG. 2B shows that each of the camera systems 110 has an optical FOV 186. The optical FOV 186 of each camera system 110 is sized to capture one plate segment 184 in its entirety. In one example, each of the optical FOVs 186 may have a diameter of about 36 mm, while the dimensions of each of the plate segments 184 may be about 34.50 mm×33.75 mm. Accordingly, because each plate segment 184 is substantially square and each optical FOV 186 is substantially circular, the optical FOVs 186 may overlap slightly, as shown in FIG. 2C.

Referring now to FIG. 1 through FIG. 2C, optical FOV 186a of camera system 110a of six read-head optical detection system 100 may correspond to plate segment 184a of 384-well microplate 180. Optical FOV 186b of camera system 110b may correspond to plate segment 184b of 384-well microplate 180. Optical FOV 186c of camera system 110c may correspond to plate segment 184c of 384-well microplate 180. Optical FOV 186d of camera system 110d may correspond to plate segment 184d of 384-well microplate 180. Optical FOV 186e of camera system 110e may correspond to plate segment 184e of 384-well microplate 180. Optical FOV 186f of camera system 110f may correspond to plate segment 184f of 384-well microplate 180.

In operation, six read-head optical detection system 100 is held stationary with respect to, for example, 384-well microplate 180. Assays may be performed with one or more of the wells 182 of 384-well microplate 180. The assays (or chemistry) may be facilitated using liquid handling system 190. During a detection step of the workflow, each of the six camera systems 110 of six read-head optical detection system 100 may capture an image of its corresponding plate segment 184 of 384-well microplate 180. More specifically, at substantially the same time, each of the camera systems 110a, 110b, 110c, 110d, 110e, and 110f may take a snapshot of its corresponding plate segment 184 of 384-well microplate 180.

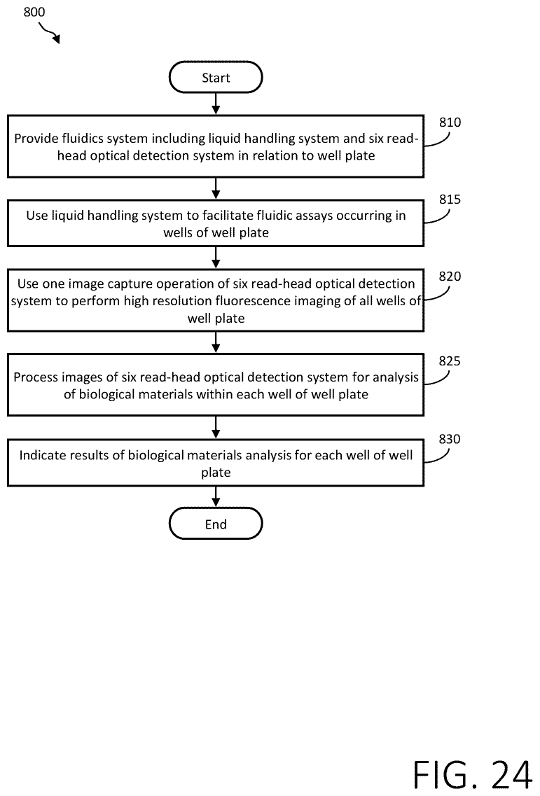

Accordingly, during the detection step, which is an image capture step, six digital images from six read-head optical detection system 100 are available for processing. Together the six images capture substantially the entirety of 384-well microplate 180 with its 384 wells 182. Next, each of the six digital images may be processed with respect to determining the contents of each individual well 182 of 384-well microplate 180. That is, certain pixels of each of the six digital images may be mapped to a specific well 182 of 384-well microplate 180. Then, each pixel group may be processed with respect to determining the contents of its corresponding well 182. An example of a fluidics system and method for processing digital images from six read-head optical detection system 100 is shown and described below in FIG. 23 and FIG. 24.

FIG. 3 through FIG. 12 show examples of various configurations of six read-head optical detection system 100. In some examples, the placement of the light sources may vary. In other examples, the placement of the image sensors may vary.

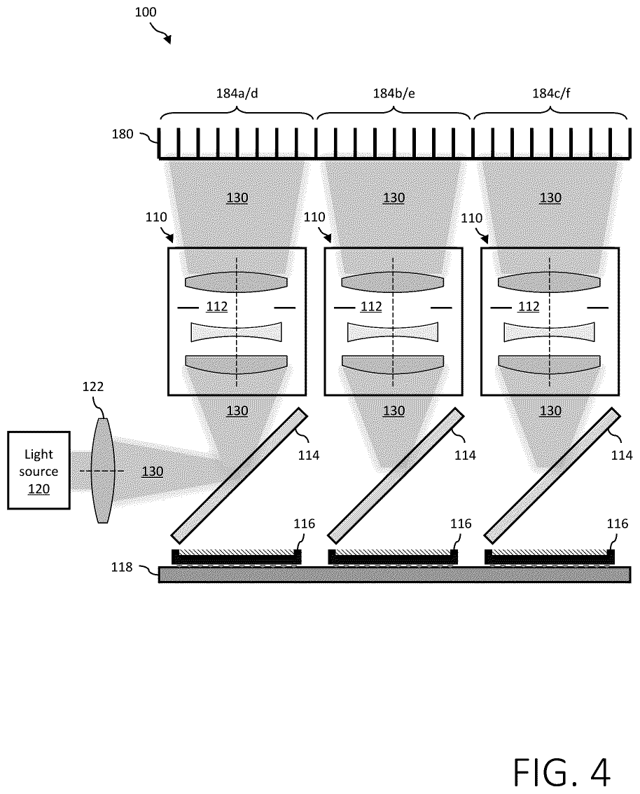

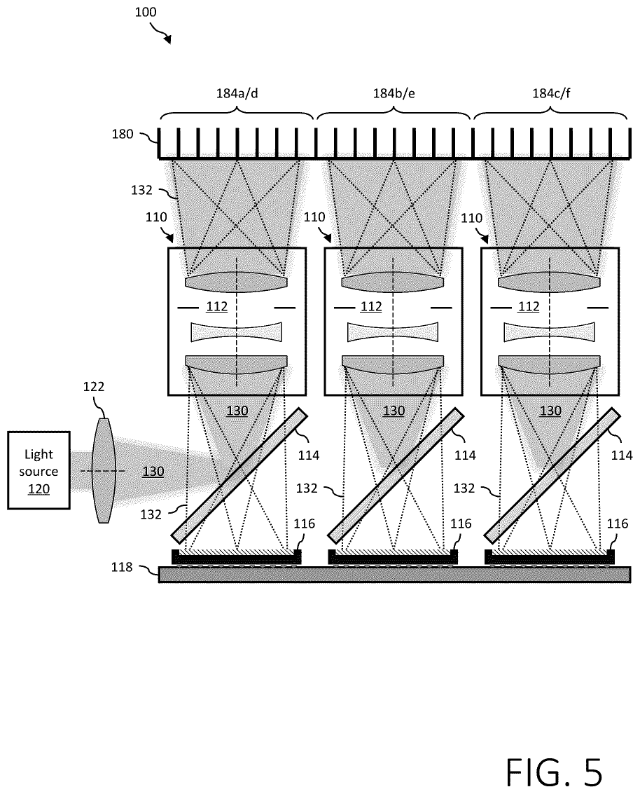

Referring now to FIG. 3, FIG. 4, and FIG. 5 is side views of an example of one configuration of the six read-head optical detection system 100 shown in FIG. 1. In this example, six read-head optical detection system 100 may include the six camera systems 110 (e.g., camera systems 110a, 110b, 110c, 110d, 110e, and 110f). Each of the camera systems 110 may include, for example, a large-scale compound lens 112, a dichroic mirror 114, an image sensor 116 mounted on a printed circuit board (PCB) 118, and a light source 120 that has a focusing lens 122. Further, in this configuration, six read-head optical detection system 100 is arranged beneath 384-well microplate 180. Further, liquid handling system 190 (not shown) may be is arranged above 384-well microplate 180.

FIG. 3 shows six read-head optical detection system 100 in an idle state. FIG. 4 shows six read-head optical detection system 100 with light source 120 activated and showing the path of the resulting excitation light 130 directed toward 384-well microplate 180. Then, FIG. 5 shows the resulting emission light 132 returning from 384-well microplate 180 to image sensors 116.

In the configuration shown in FIG. 3, FIG. 4, and FIG. 5, camera system 110 may include large-scale compound lens 112, dichroic mirror 114, and image sensor 116 arranged in a line from top to bottom. Then, light source 120 (e.g., an LED or laser light source) with its focusing lens 122 is positioned to the side of camera system 110. For example, light source 120 may be arranged to the side and in relation to dichroic mirror 114.

In this example, light source 120 is directed at dichroic mirror 114 that reflects the excitation light 130 into large-scale compound lens 112 and toward 384-well microplate 180, as shown in FIG. 4. Then, emission light 132 returning from 384-well microplate 180 passes in the opposite direct through large-scale compound lens 112. Emission light 132 then passes through dichroic mirror 114 to image sensor 116.

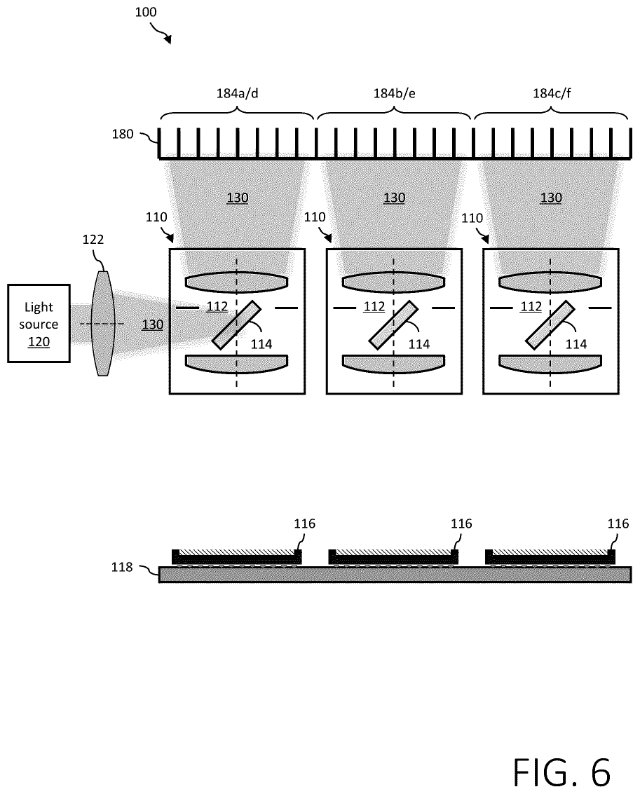

Referring now to FIG. 6 is a side view of an example of another configuration of the six read-head optical detection system 100 shown in FIG. 1. In this configuration, dichroic mirror 114 is integrated into the large-scale compound lens 112 instead of between large-scale compound lens 112 and image sensor 116. Accordingly, light source 120 may be arranged to the side and in relation to dichroic mirror 114 in large-scale compound lens 112.

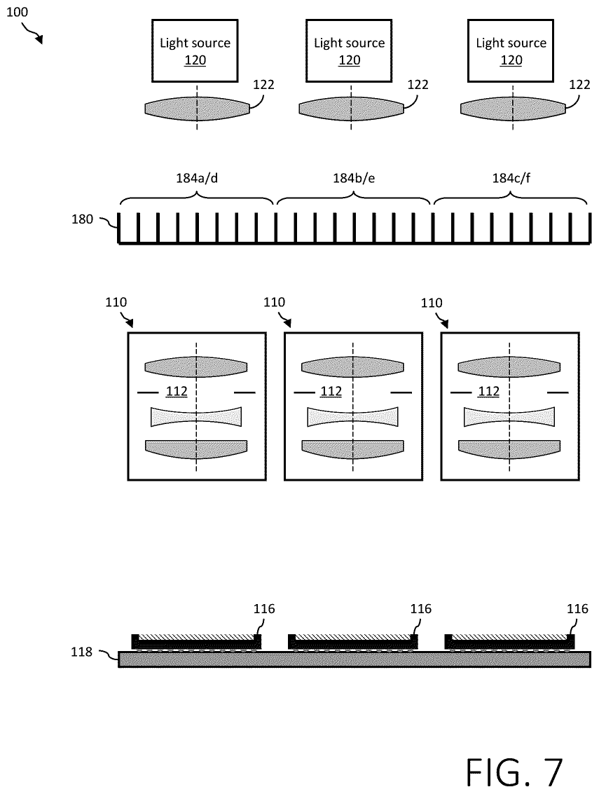

In the configurations shown in FIG. 3 through FIG. 6, excitation light 130 from light source 120 originates from beneath 384-well microplate 180. However, FIG. 7 shows a configuration of six read-head optical detection system 100 in which the light sources 120 (and focusing lenses 122) may be arranged above 384-well microplate 180. In this example, no dichroic mirrors 114 are required.

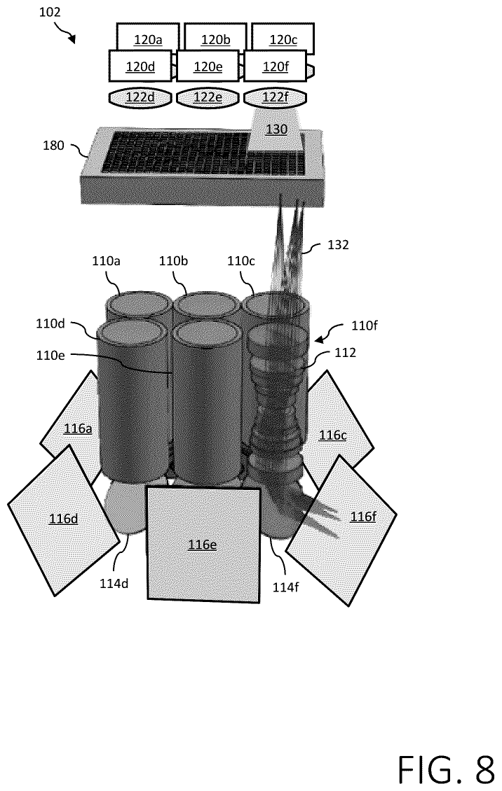

In the configurations of six read-head optical detection system 100 shown in FIG. 3 through FIG. 7, the six image sensors 116 may be laying flat in a plane atop PCB 118. That is, each image sensor 116 may be laying flat and facing upward toward the end of its corresponding large-scale compound lens 112. However, this configuration requires the six image sensors 116 to be small enough to lay flat within the space defined by the size of plate segments 184. That is, in this configuration, the maximum physical size of one image sensor 116 may be limited by the spacing between camera systems 110. More specifically, the size of one image sensor 116 may be limited to about the same size as one plate segment 184 (e.g., about 34.50 mm×33.75 mm). By contrast, an example of a six read-head optical detection system that can use larger image sensors 116 is shown and described below in FIG. 8 through FIG. 12.

Further, in the configurations of six read-head optical detection system 100 shown in FIG. 3 through FIG. 7, certain specifications may include—(1) six camera systems 110, (2) FOV: 8×8 wells per camera system 110, and (3) large-scale compound lens 112 of each camera system 110 may have a numerical aperture (NA) of, for example, ˜0.1. However, in these configurations, those skilled in the art may recognize that the NA may be limited by the spacing between camera systems 110. Further, a main feature of six read-head optical detection systems 100 may include fast single-shot imaging. For example, six read-head optical detection system 100 may use one image capture event and then process the resulting six images to analyze, for example, all 384 wells 182 of the 384-well microplate 180. A process that may take about 10 seconds. By contrast, existing optical detection processes are slow because the well plates are imaged and processed one well at a time. For example, if it takes about one second to image and process one well, it may take up to about 384 seconds (more than 6 minutes) to perform optical detection on a 384-well microplate.

Referring now to FIG. 8 is a perspective view of an example of a six read-head optical detection system 102, which is another example of the six read-head optical detection system 100 shown in FIG. 1. The configuration of six read-head optical detection system 102 may be substantially the same as the configuration shown in FIG. 7, except that the six image sensors 116 are not arranged flat in a plane below the six camera systems 110. Rather, the six image sensors 116 are arranged on edge, like a fence surrounding the six camera systems 110. That is, each image sensor 116 may be arranged on edge and facing inward toward the side of its corresponding large-scale compound lens 112.

This orientation of image sensors 116 may be needed because the size of each image sensor 116 may exceed the size of one plate segment 184 (e.g., about 34.50 mm×33.75 mm). In one example, in six read-head optical detection system 102, each image sensor 116 may be the Sony IMX661 Sensor available from Sony Corporation (Tokyo, Japan). The IMX661 Sensor is a large format 56.73 mm diagonal CMOS image sensor designed for industrial equipment. The IMX661 Sensor has a global shutter function and a high effective pixel count of 127.68 megapixels. Accordingly, the Sony IMX661 Sensor may provide a high-resolution image sensor that supports high resolution fluorescence imaging.

Further, in six read-head optical detection system 102, each camera system 110 uses its dichroic mirror 114 to direct emission light 132 toward its image sensor 116. Using camera system 110f as an example in FIG. 8, light source 120f is activated and generates excitation light 130 that is directed toward 384-well microplate 180. Then, the resulting emission light 132 is collected by large-scale compound lens 112f of each camera system 110f. FIG. 8 shows a transparent view of camera system 110f and shows an example of large-scale compound lens 112f that may include, for example, a lens train. Emission light 132 passes through large-scale compound lens 112f and then strikes dichroic mirror 114f. The dichroic mirror 114f then reflects the emission light 132 toward image sensor 116f, as shown in FIG. 8. In six read-head optical detection systems 100 and 102, the diameter of the barrel containing each camera system 110 may be limited to about one sixth the area of the well plate 180.

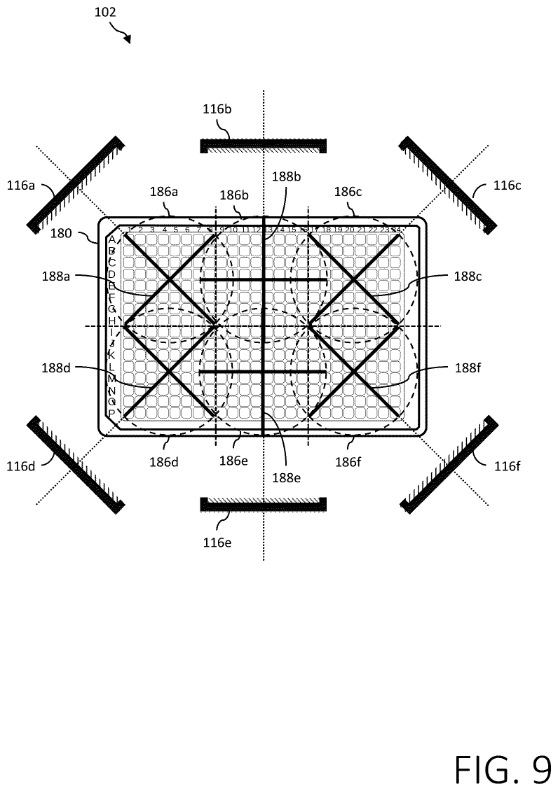

Referring still to FIG. 8, image sensors 116b and 116e, which are the side middle sensors of the 2×3 arrangement, are oriented on one edge as shown. Further, image sensors 116a, 116c, 116d, and 116f, which are the corner sensors of the 2×3 arrangement, are rotated 45 degrees compared with image sensors 116b and 116e. This is further illustrated in FIG. 9 that shows a plan view of the six image sensors 116 in relation to 384-well microplate 180. FIG. 9 shows the line of sight for each of the six image sensors 116. FIG. 9 also shows an image orientation 188 with respect to its corresponding plate segment 184 for each of the six image sensors 116. In this example, image orientations 188b and 188e of image sensors 116b and 116e, respectively, are straight across with respect to their corresponding plate segments 184b and 184e. While image orientations 188a, 188c, 188d, and 188f of image sensors 116a, 116c, 116d, and 116f, respectively, are diagonal with respect to their corresponding plate segment 184a, 184c, 184d, and 184f.

In six read-head optical detection system 102 shown in FIG. 8 and FIG. 9, certain specifications may include—(1) six camera systems 110, (2) FOV: 8×8 wells per camera system 110, and (3) large-scale compound lens 112 of each camera system 110 may have an NA of, for example, ˜0.1. Further, a main feature of six read-head optical detection system 102 may include fast single-shot imaging. For example, six read-head optical detection system 102 may use one image capture event and then process the resulting six images to analyze, for example, all 384 wells 182 of the 384-well microplate 180. A process that may take about 10 seconds. By contrast, existing optical detection processes are slow because the well plates are imaged and processed one well at a time. For example, if it takes about one second to image and process one well, it may take up to about 384 seconds (more than 6 minutes) to perform optical detection on a 384-well microplate.

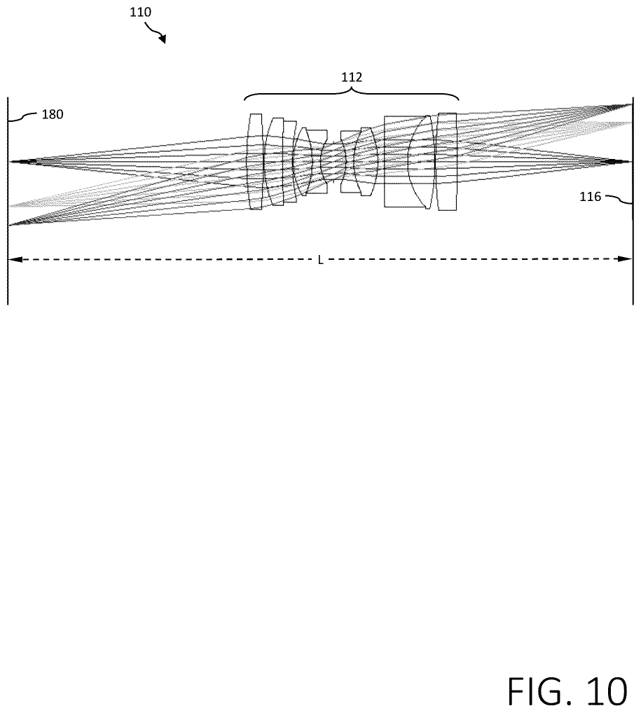

Further, in six read-head optical detection system 102 the distance between 384-well microplate 180 and large-scale compound lens 112 of each camera system 110 may be about 84 mm. The overall length of large-scale compound lens 112 of each camera system 110 may be about 88 mm long. The lens diameter of large-scale compound lens 112 of each camera system 110 may be about 34 mm. Further, FIG. 10 is a side view showing more details of large-scale compound lens 112 of each camera system 110. Again, large-scale compound lens 112 may include any arrangements of optical components, such as, but not limited to, optical lenses, optical filters, mirrors, prisms, polarizers, gratings, and the like. In one example, the total axial length L between 384-well microplate 180 and image sensors 116 may be about 250 mm.

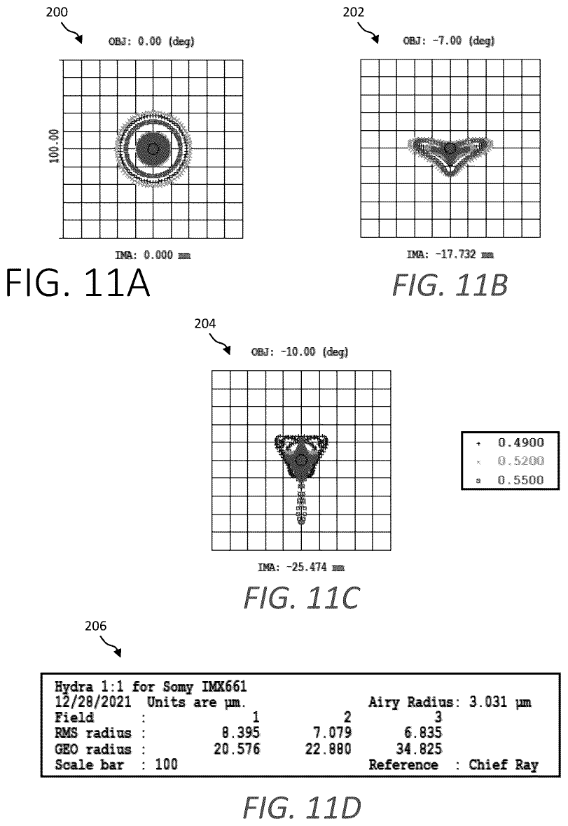

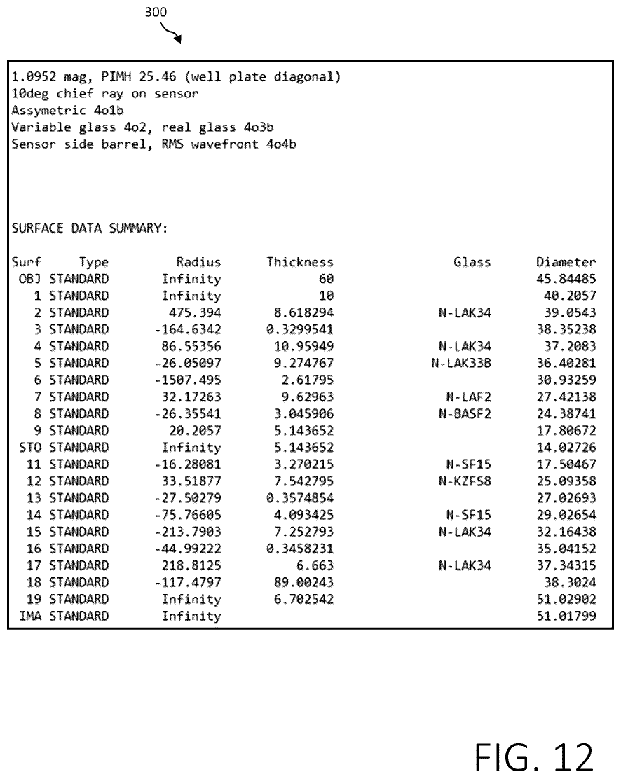

Referring now to FIG. 11A, FIG. 11B, FIG. 11C, and FIG. 11D is examples of spot diagrams of the large-scale compound lenses 112 of the six read-head optical detection system 102 shown in FIG. 8 and FIG. 9. For example, FIG. 11A shows a spot diagram 200. FIG. 11B shows a spot diagram 202. FIG. 11C shows a spot diagram 204. FIG. 11D shows a table 206. Further, FIG. 12 shows a table 300 indicating an example of the “prescription” of the large-scale compound lens 112 of each camera system 110 of six read-head optical detection system 102.

The multiple read-head configurations are not limited to six camera systems 110 as shown in six read-head optical detection systems 100 and 102, other configurations of cameras are possible. For example, other multiple read-head optical detection systems may include twelve camera systems 110, twenty-four camera systems 110, up to one camera system 110 per well. However, these configurations may be driven by certain parameters, such as, but not limited to, cost, complexity, resolution/FOV of the image sensor, resolution that may be needed to do the required analysis, and so on.

### Step-and-Shoot Optical Detection

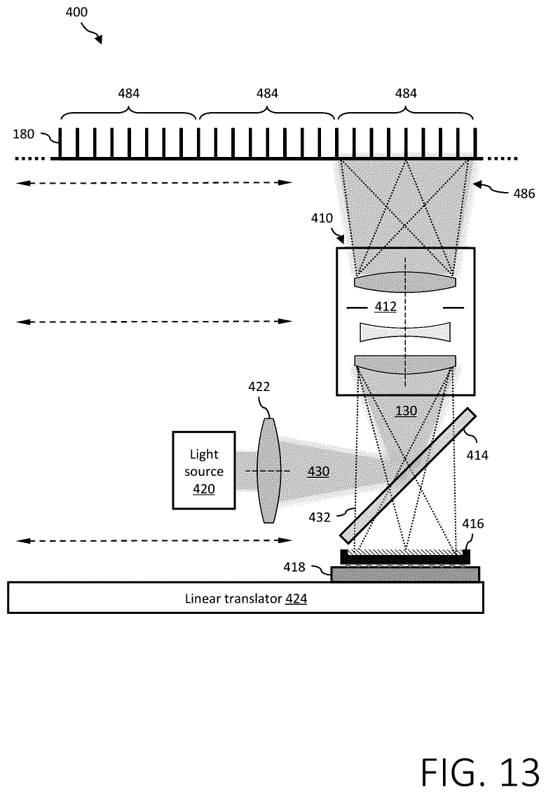

Referring now to FIG. 13 is a side view of an example of a step-and-shoot optical detection system, which is a 6-step step-and-shoot optical detection system 400, in accordance with an embodiment of the disclosure. The 6-step step-and-shoot optical detection system 400 may include, for example, a camera system 410 mounted atop a linear translator 424. Linear translator 424 may be, for example, any X-Y stage for stepping camera system 410 with respect to a well plate, such as 384-well microplate 180.

Camera system 410 of 6-step step-and-shoot optical detection system 400 may be substantially the same as one camera system 110 of six read-head optical detection system 100 or 102. Camera system 410 may include, for example, a large-scale compound lens 412, a mirror 414, an image sensor 416 mounted on a PCB 418, and a light source 420 that has a focusing lens 422. In some cases, the mirror 414 may be a dichroic mirror, partially reflective mirror, or a beam splitter. Further, in this configuration, 6-step step-and-shoot optical detection system 400 may be arranged beneath and/or above a 384-well microplate 180. Further, liquid handling system 190 (not shown) may be arranged above and/or below the 384-well microplate 180. Further, light source 420 of camera system 410 may be arranged below or above well plate.

In 6-step step-and-shoot optical detection system 400 shown in FIG. 13, certain specifications may include-(1) one camera system 410, (2) FOV of camera system 410 may be one sixth of a well plate, (3) camera system 410 may be stepped through six positions, and (4) large-scale compound lens 412 may have an NA of, for example, ˜0.1. Further, 6-step step-and-shoot optical detection system 400 may be more simple and less costly than six read-head optical detection systems 100, 102.

Further, a main feature of 6-step step-and-shoot optical detection system 400 may include fast six-shot imaging. For example, 6-step step-and-shoot optical detection system 400 may use six image capture events and then process the resulting six images to analyze, for example, all 384 wells 182 of the 384-well microplate 180. A process that may take about 10 seconds or less than about 10 seconds. By contrast, existing optical detection processes are slow because the well plates are imaged and processed one well at a time. For example, if it takes about one second to image and process one well, it may take up to about 384 seconds (more than 6 minutes) to perform optical detection on a 384-well microplate.

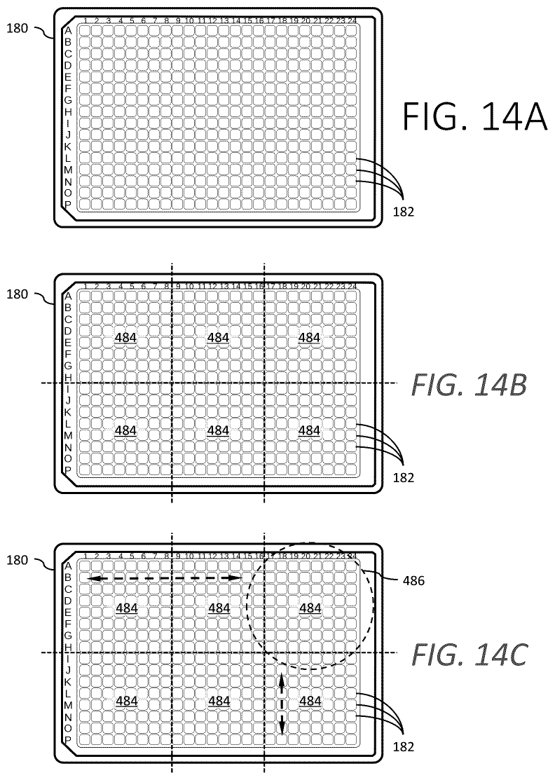

In 6-step step-and-shoot optical detection system 400, it may take six steps of camera system 410 to capture the entirety of a well plate. That is, the FOV (e.g., a FOV 486) of camera system 410 may be sized to capture a plate segment 484 of a well plate, such as 384-well microplate 180 as shown in FIG. 14A, FIG. 14B, and FIG. 14C. In this example, each plate segment 484 may include a 4×4 arrangement of wells 182.

Referring now to FIG. 14A, FIG. 14B, and FIG. 14C illustrate planar views of an example of the field-of-view of 6-step step-and-shoot optical detection system 400 in relation to 384-well microplate 180. In the case of 384-well microplate 180, each plate segment 484 and step of 6-step step-and-shoot optical detection system 400 may be an 8×8-well portion. Each plate segment 484 includes a different 64 wells 182 out of the 384 wells 182.

In other examples, for a 6-well microplate each plate segment 484 and step is a 1-well segment. For a 24-well microplate each plate segment 484 and step may be a 2×2-well segment. For a 96-well microplate each plate segment 484 and step may be a 4×4-well segment. For a 1536-well microplate each plate segment 484 and step may be a 16×16-well segment.

FIG. 14A shows a plan view of an example of 384-well microplate 180 that includes the 16×24 arrangement of wells 182. FIG. 14B shows the well area of 384-well microplate 180 that may be divided into six plate segments 484. Therefore, each plate segment 484 may contain an 8×8 arrangement of wells 182. Each plate segment 484 may include a different 64 wells 182 out of the 384 wells 182. Accordingly, FOV 486 of camera system 410 may be sized to capture one plate segment 484, as shown in FIG. 14C. Linear translator 424 can be used to step camera system 410 from one plate segment 484 to the next. In so doing, the entirety of 384-well microplate 180 may be imaged using 6-step step-and-shoot optical detection system 400. That is, the six steps may result in six snapshots of camera system 410 and accordingly six images to process to reconstruct the entirety of the 384 well microplate 180.

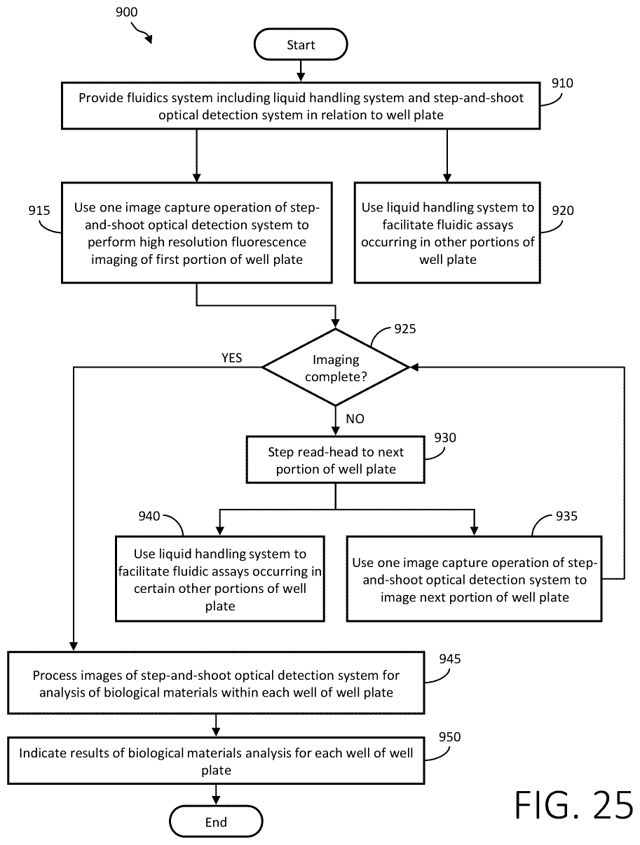

For example, during the detection step, six digital images from 6-step step-and-shoot optical detection system 400 may be generated and subsequently processed. Together the six images may capture substantially the entirety of 384-well microplate 180 with its 384 wells 182. Next, each of the six digital images may be processed with respect to determining the contents of each individual well 182 of 384-well microplate 180. That is, certain pixels of each of the six digital images may be mapped to a specific well 182 of 384-well microplate 180. Then, each pixel group may be processed with respect to determining the contents of its corresponding well 182. An example of a fluidics system including 6-step step-and-shoot optical detection system 400 is shown and described below in FIG. 23. An example of a method for using 6-step step-and-shoot optical detection system 400 is shown and described below in FIG. 25.

Further, in 6-step step-and-shoot optical detection system 400, image capture operations may occur, for example, at a certain plate segment 484 of 384-well microplate 180 while at substantially the same time certain fluidics operations (using liquid handling system 190) may occur at different plate segments 484 of 384-well microplate 180 that are not being imaged. These simultaneous actions in 6-step step-and-shoot optical detection system 400 may image an entirety of a 384-well microplate and/or greater than a 384-well microplate in a shorter period of time (e.g., about or less than about 10 seconds) when compared with existing well plate optical detection processes that require several minutes of imaging time.

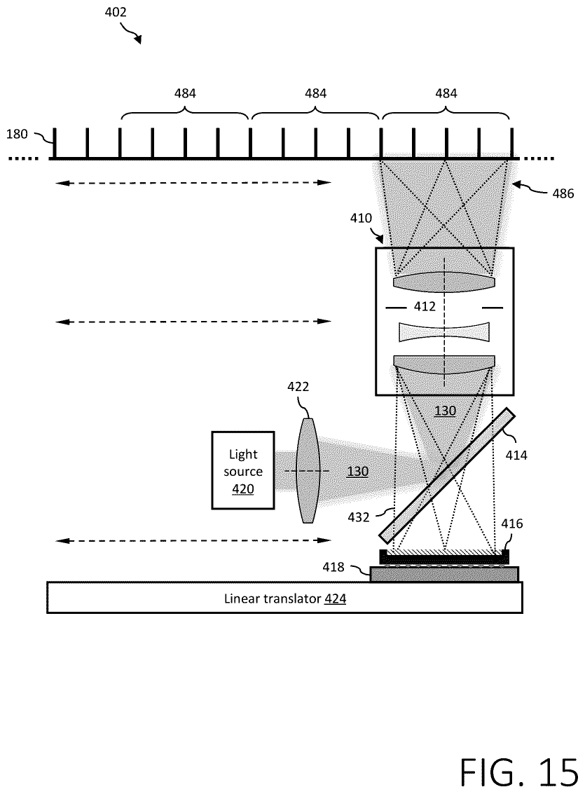

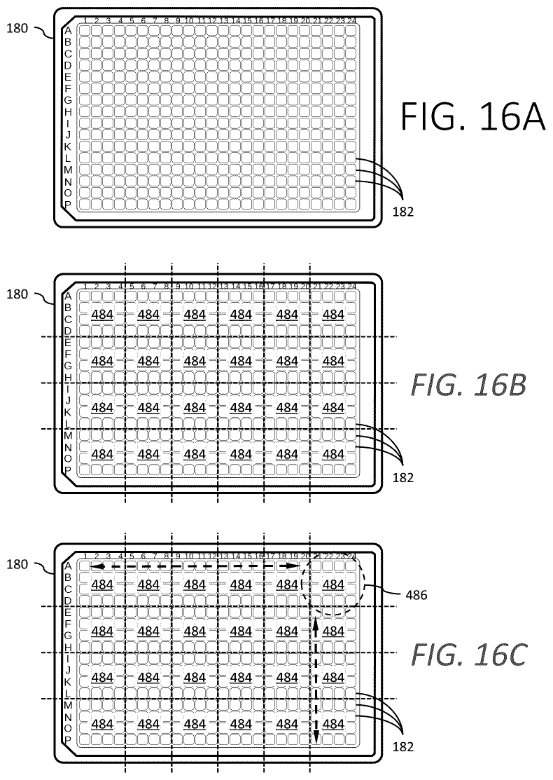

FIG. 15 shows a side view of another example of a step-and-shoot optical detection system, which is a 24-step step-and-shoot optical detection system 402, in accordance with an embodiment of the disclosure. The 24-step step-and-shoot optical detection system 402 may include, for example, the camera system 410 mounted atop linear translator 424 similar to the FIG. 13 6-step step and shoot optical system 400, as described above.

The 24-step step-and-shoot optical detection system 402, may take twenty-four steps of camera system 410 to capture the entirety of a well plate 180. That is, the FOV (e.g., a FOV 486) of camera system 410 may be sized to capture a plate segment 484 of a well plate, such as 384-well microplate 180 as shown in FIG. 16A, FIG. 16B, and FIG. 16C. Camera system 410 of 24-step step-and-shoot optical detection system 400 may be substantially the same as one camera system 110 of six read-head optical detection system 100 or 102, but may be sized differently and/or have different specifications. For example, the optics of camera system 410 of 24-step step-and-shoot optical detection system 402 may be about one quarter the size of the optics of camera system 410 of the 6-step step-and-shoot optical detection system 400.

In 24-step step-and-shoot optical detection system 402 shown in FIG. 15, certain specifications may include-(1) one camera system 410, (2) FOV 486 of camera system 410 is one twenty-fourth of a well plate (e.g., a 384 well plate as described elsewhere herein), (3) camera system 410 is stepped through twenty-four positions, and/or (4) large-scale compound lens 412 may have an NA expected at least about ˜0.1 at least about a 40 mm lens diameter or at least about ˜0.15 at least about a 80 mm lens diameter. Further, the 24-step step-and-shoot optical detection system 402 may be simpler (e.g., based on the number of optical components and necessarily alignment required) and less costly based at least on the quantity of optical components in comparison to the six read-head optical detection systems 100, 102.

Further, a main feature of 24-step step-and-shoot optical detection system 402 may include fast 24-shot imaging. For example, the 24-step step-and-shoot optical detection system 402 may use twenty-four image capture events to produce twenty-four images to analyze, for example, all 384 wells 182 of the 384-well microplate 180. A process that may take about 30 seconds. By contrast, existing optical detection processes are slow because the well plates are imaged and processed one well at a time. For example, if it takes about one second to image and process one well, it may take up to about 384 seconds (more than 6 minutes) to perform optical detection on a 384-well microplate.

FIG. 16A, FIG. 16B, and/or FIG. 16C show plan views of an example of the field-of-view of the 24-step step-and-shoot optical detection system 402 in relation to 384-well microplate 180. In the case of 384-well microplate 180, each plate segment 484 and step of 24-step step-and-shoot optical detection system 402 may be a 4×4-well segment. Each plate segment 484 may include a different 16 wells 182 out of the 384 wells 182.

In other examples, for a 24-well microplate each plate segment 484 and step may be a 1-well segment. For a 96-well microplate each plate segment 484 and step may be a 2×2-well segment. For a 1536-well microplate each plate segment 484 and step may be an 8×8-well segment.

FIG. 16A shows a plan view of an example of 384-well microplate 180 that includes the 16×24 arrangement of wells 182. FIG. 16B shows the well area of 384-well microplate 180 that may be divided into twenty-four plate segments 484. Therefore, each plate segment 484 may contain a 4×4 arrangement of wells 182. Each plate segment 484 may include a different 16 wells 182 out of the 384 wells 182. Accordingly, FOV 486 of camera system 410 may be sized to capture one plate segment 484, as shown in FIG. 16C. Linear translator 424 can be used to step camera system 410 from one plate segment 484 to the next. In so doing, the entirety of 384-well microplate 180 may be imaged using 24-step step-and-shoot optical detection system 402. That is, the twenty-four steps may result in twenty-four snapshots of camera system 410 and accordingly twenty-four images that may then subsequently be processed.

For example, during the detection step, twenty-four digital images from 24-step step-and-shoot optical detection system 402 may be available for processing. Together the twenty-four images may capture substantially the entirety of 384-well microplate 180 with its 384 wells 182. Next, each of the twenty-four digital images may be processed with respect to determining the contents of each individual well 182 of 384-well microplate 180. That is, certain pixels of each of the twenty-four digital images may be mapped to a specific well 182 of 384-well microplate 180. Then, each pixel group may be processed with respect to determining the contents of its corresponding well 182. An example of a fluidics system including 24-step step-and-shoot optical detection system 402 is shown and described below in FIG. 23. An example of a method for using 24-step step-and-shoot optical detection system 402 is shown and described below in FIG. 25.

Further, in 24-step step-and-shoot optical detection system 402, image capture operations may occur, for example, at a certain plate segment 484 of 384-well microplate 180 while at substantially the same time certain fluidics operations (using liquid handling system 190) may occur at different plate segments 484 of 384-well microplate 180 that are not being imaged. These simultaneous actions in 24-step step-and-shoot optical detection system 402 may save time in a manner similarly described elsewhere herein with respect to existing well plate optical detection processes.

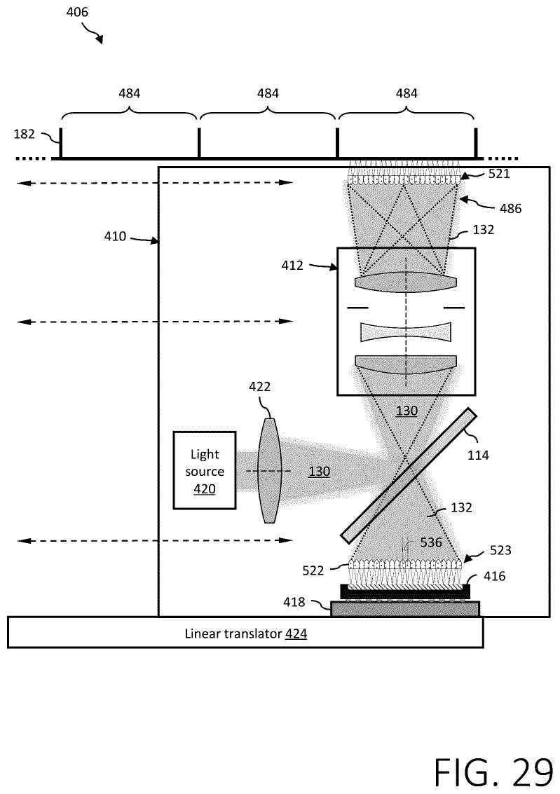

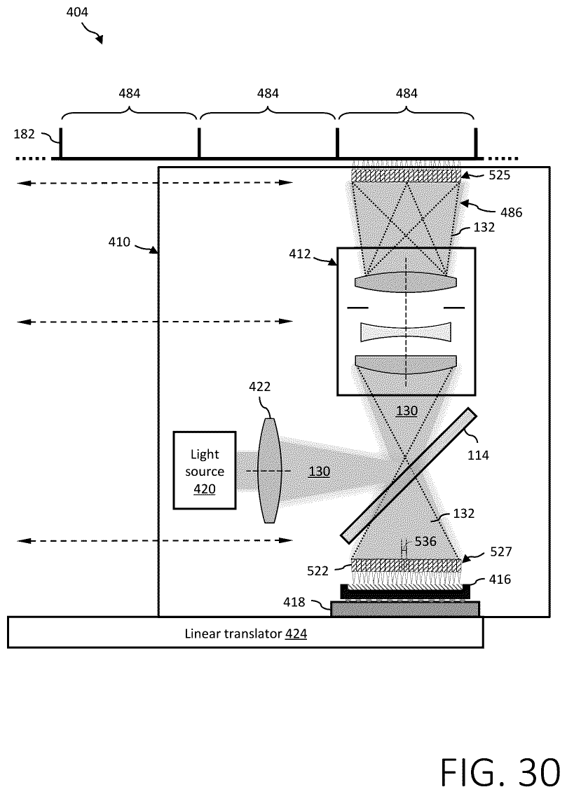

In some embodiments, the optical system as described elsewhere herein, may comprise a high resolution (e.g., super resolution imaging at or below about the diffraction limit of light emitted from a biological material) step and shoot optical system (404, 406), as shown in FIGS. 29 and 30. In some cases, the high resolution step and shoot optical detection system may comprise a multiscale GRIN lens high resolution step and shoot optical detection system 404, as shown in FIG. 30 or a multiscale micro lens high resolution step and shoot optical detection system 406, as shown in FIG. 29. The high resolution step and shoot optical detection system(s), as described herein, may be configured to image a segment of a well plate 484 e.g., a surface of a single well of a multi-well plate 182 with a resolution of less than about the diffraction limit of light emitted by one or more biological material(s) disposed within a well, adjacent a well surface (e.g., suspended in a solution in a well), and/or immobilized on the well surface. The light emitted by one or more biological materials may be the result of a fluorescent reaction initiated by providing an excitation light source 420 to the biological materials. In some cases, the one or more biological material(s) may be disposed adjacent and/or immobilized on a surface of a well at distances of less than about the diffraction limit of light emitted from the one or more biological materials as a result of a fluorescence reaction. In some cases, the one or more biological material(s) may be disposed adjacent and/or immobilized on a surface of a well with a spacing between a first biologic material and a second biological material of at least about 100 nanometers. The high resolution step and shoot optical detection systems as described herein may permit high throughput analysis of high density biological materials disposed within a well. Such high resolution step and shoot optical detection systems increase the data obtained from a single community, reaction, assay, or any combination thereof occurrence within a well of a multi-well plate.

In some cases, the multiscale micro lens high resolution step and shoot optical detection system 406, as shown in FIG. 29, and/or the multiscale GRIN lens high resolution step and shoot optical detection system 404, may comprise a camera system 410. The camera system may comprise a large-scale compound lens 412, a mirror 414, an image sensor 416 mounted on a PCB 418, a light source 420, focusing lens 422, one or more multiscale GRIN lenses (525, 527), one or more multiscale micro lenses (523, 521), or any combination thereof. In some cases, the camera may generate one or more images of biological material(s) disposed on and/or adjacent a segment of a well 484 on an image sensor 416. The camera 410 may be disposed on a stage (e.g., a linear translator) 424 that translates the camera to generate one or more images of a segment 484 of a different well.

In some cases, the multiscale micro lens high resolution step and shoot optical detection system 406 (FIG. 29) camera 410 may comprise a light source 420, described elsewhere herein, where an excitation light from the light source 130 may be optically coupled with a mirror 114 (e.g., dichroic, beam splitter, etc.) through a focusing lens 422. The mirror 114 may comprise a coating and/or material configured to reflect the excitation light from the light source 130 and transmit emission light from the well microplate 132 to the image sensor 416. In some cases, the excitation light from the light source 130 may reflect off of the mirror 114 at an angle that is the same as an angle of incidence of the emission light 130 the mirror. In some cases, the mirror may be positioned at least about 20 degrees, at least about 30 degrees, at least about 40 degrees, or at least about 45 degrees with respect to the optical axis of the output of the excitation light 130 of the light source 420. The reflected emission light from the light source 130 from the mirror 114 may be optically coupled to a large-scale compound lens, as described elsewhere herein. The resulting transmitted excitation light may be directed to a first micro lens element 521. In some cases, the first micro lens element 521 may comprise one or more micro lenses 522. In some instances, the center-to-center spacing 536 of the one or more micro lenses may be at least about 100 nanometers (nm). In some cases, the center-to-center spacing of the one or more micro lenses may comprise a distance 536 of less than about the diffraction limit of light emitted from the biological material(s) when provided an excitation light 130 of the light source 420. In some cases, the center-to-center distance 536 of the one or more micro lenses of the first micro lens element 521 or second micro lens element 523, enables the optical system(s), described elsewhere herein to generate an image of each biological material disposed adjacent or on a surface of a well of a multi-well plate when at least two biological materials are separated by a distance of less than the diffraction limit of light emitted from either a first or second biological material of the at least two biological materials. The presence of the first micro lens element 521 or the second micro lens element 523 and the spacing of the lens elements of each of the first micro lens element 521 and/or the second micro lens element 523 allows for high throughput imaging of high density cultures, colonies, agglomerates, assays, etc., of the biological materials. The first micro lens element 521 may focus the excitation light on the biological materials disposed adjacent and/or immobilized to a surface of a well of a multi-well plate 182. At least as a result of the biological material(s) absorbing the excitation light, the biological materials may emit or radiate an emission light 132. The emission light from a segment of a well 484 may be optically coupled to the first micro lens element 521 and further optically coupled to the large-scale compound lens 412. The emission light 132 may be relayed and/or coupled by the first micro lens element 521 and/or the large-scale compound lens 412 to the mirror 114. The mirror may transmit the emission light 132 towards the second micro lens element 523. The second micro lens element 523 may focus and/or relay the emission light 132 onto and/or towards the image sensor 416. The image sensor may detect, observe, and/or collect the emission light 132 photons and in electrical communication with the PCB relay the corresponding electrical signal representative of the detected, observed, and/or collected photons to other aspects of the optical imaging system, as described elsewhere herein.

In some cases, the multiscale GRIN lens high resolution step and shoot optical detection system 404 (FIG. 30) camera 410 may comprise a light source 420, described elsewhere herein, where an excitation light from the light source 130 may be optically coupled with a mirror 114 (e.g., dichroic, beam splitter, etc.) through a focusing lens 422. The mirror 114 may comprise a coating and/or material configured to reflect the excitation light from the light source 130 and transmit emission light from the well microplate 132 to the image sensor 416. In some cases, the excitation light from the light source 130 may reflect off of the mirror 114 at an angle that is the same as an angle of incidence of the emission light 130 onto the mirror. In some cases, the mirror may be positioned at least about 20 degrees, at least about 30 degrees, at least about 40 degrees, or at least about 45 degrees with respect to the optical axis of the output of the excitation light 130 of the light source 420. The reflected emission light from the light source 130 from the mirror 114 may be optically coupled to a large-scale compound lens, as described elsewhere herein. The resulting transmitted excitation light may be directed to a first GRIN lens element 525. In some cases, the first GRIN lens element 525 may comprise one or more GRIN lenses 522. In some instances, the center-to-center spacing 536 of the one or more GRIN lenses may be at least about 100 nanometers (nm). In some cases, the center-to-center spacing of the one or more GRIN lenses may comprise a distance 536 of less than about the diffraction limit of light emitted from the biological material(s) when provided an excitation light 130 of the light source 420. In some cases, the center-to-center distance 536 of the one or more micro lenses of the first GRIN lens element 525 or second GRIN lens element 527, enables the optical system(s), described elsewhere herein to generate an image of each biological material disposed adjacent or on a surface of a well of a multi-well plate when at least two biological materials are separated by a distance of less than the diffraction limit of light emitted from either a first or second biological material of the at least two biological materials. The presence of the first GRIN lens element 525 or the second GRIN lens element 527, and the spacing of the lens elements of each of the first GRIN lens element 525 and/or the second GRIN lens element 527 allows for high throughput imaging of high density cultures, colonies, agglomerates, assays, etc., of the biological materials. The first GRIN lens element 525 may focus the excitation light on the biological materials disposed adjacent and/or immobilized to a surface of a well of a multi-well plate 182. At least as a result of the biological material(s) absorbing the excitation light, the biological materials may emit or radiate an emission light 132. The emission light from a segment of a well 484 may be optically coupled to the first GRIN lens element 525 and further optically coupled to the large-scale compound lens 412. The emission light 132 may be relayed and/or coupled by the first GRIN lens element 525 and/or the large-scale compound lens 412 to the mirror 114. The mirror may transmit the emission light 132 towards the second GRIN lens element 527. The second GRIN lens element 527 may focus and/or relay the emission light 132 onto and/or towards the image sensor 416. The image sensor may detect, observe, and/or collect the emission light 132 photons and in electrical communication with the PCB relay the corresponding electrical signal representative of the detected, observed, and/or collected photons to other aspects of the optical imaging system, as described elsewhere herein.

### Multiscale Lens Array Optical Detection

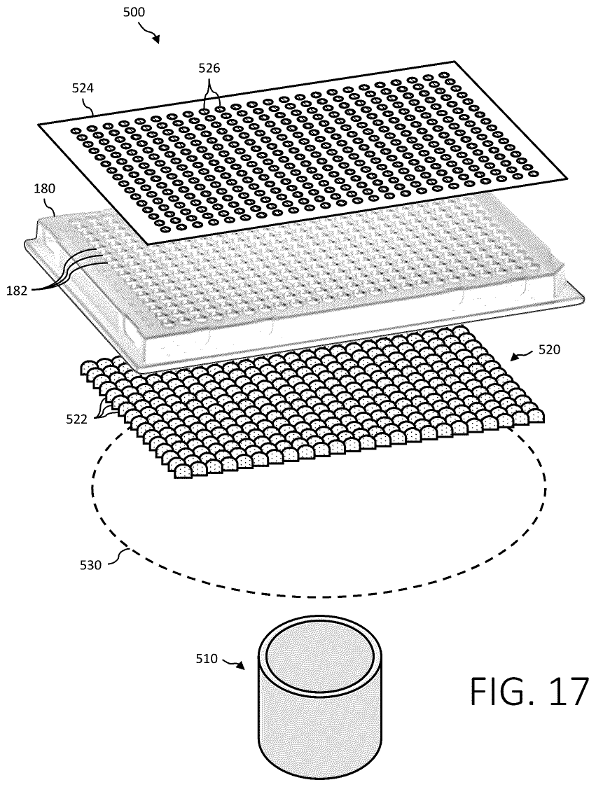

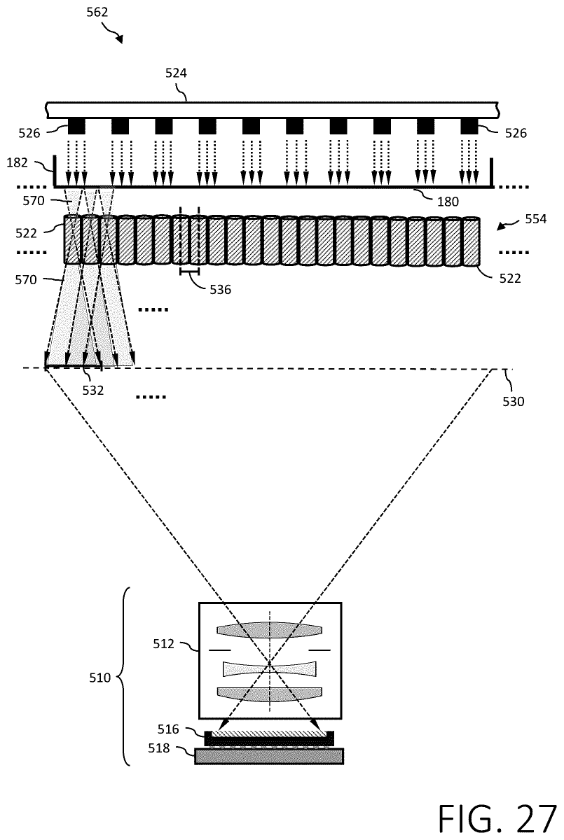

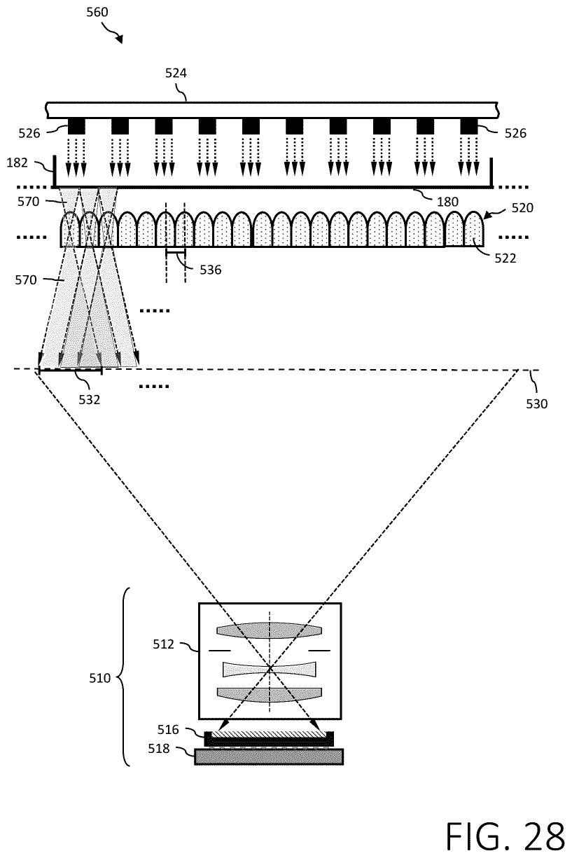

A multiscale optical system is a system having two or more lenses that work independently. Further, multiscale optical systems may provide a way to have both a large numerical aperture (NA) and a large field-of-view (FOV). Examples of multiscale optical detection systems are described below with reference to FIG. 17 through FIG. 22, and FIG. 27 to FIG. 30.

Referring now to FIG. 17 is a perspective view of an example of a multiscale microlens optical detection system 500 in relation to a well plate for processing biological materials, in accordance with an embodiment of the disclosure.

Multiscale microlens optical detection system 500 may include, for example, a camera system 510, a microlens array 520, and a light source array 524. Further, camera system 510, microlens array 520, and light source array 524 may be arranged with respect to a well plate, such as 384-well microplate 180. In one example, camera system 510 and microlens array 520 may be arranged as shown beneath 384-well microplate 180. While light source array 524 may be arranged as shown above the 384-well microplate 180. Further, liquid handling system 190, described elsewhere herein, may be arranged above 384-well microplate 180.

Microlens array 520 may include one microlens 522 per well of the well plate. For example, if the well plate is the 384-well microplate 180 as shown in FIG. 17, then microlens array 520 may include 384 microlenses 522. Further, the microlenses 522 may be arranged to substantially match the well arrangement. The 384-well microplate 180 as shown in FIG. 17, microlens array 520 may include a 16×24 arrangement of microlenses 522.

Similarly, light source array 524 may include one LED 526 per well of the well plate. For example, if the well plate is the 384-well microplate 180 as shown in FIG. 17, then light source array 524 may include 384 LEDs 526. Further, the LEDs 526 may be arranged to substantially match the well arrangement. The 384-well microplate 180 as shown in FIG. 17, light source array 524 may include a 16×24 arrangement of LEDs 526.

Light source array 524 provides an addressable LED array that may be used for virtual scanning. For example, each well 182 of 384-well microplate 180 may be addressable with a small LED 526 from light source array 524. In other embodiments, more complicated illumination systems may be possible. In one example, epifluorescence illumination may be integrated into the compound optics of camera system 510 (e.g., epifluorescence illumination compound microscope technology). In another example, the wells may be addressed by imaging a pattern onto the well plate surface using, for example, a spatial light modulator (SLM).

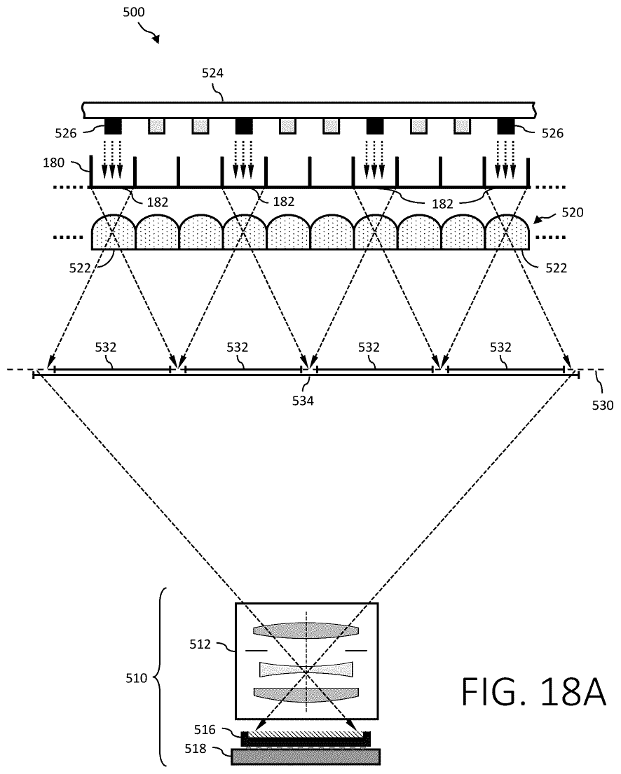

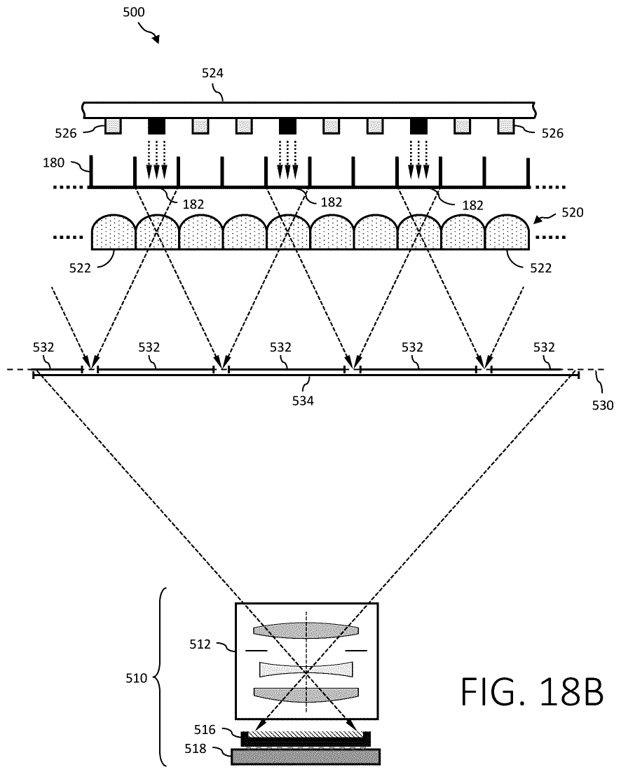

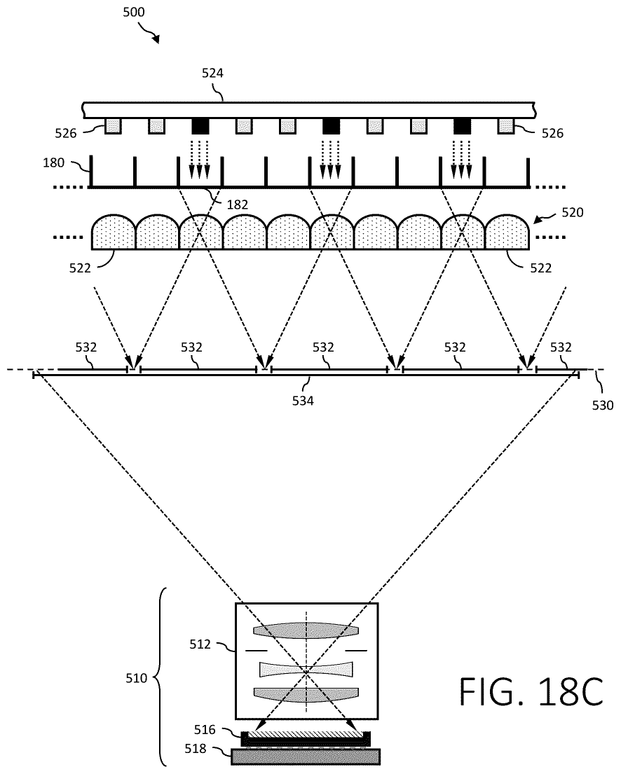

Camera system 510 may include, for example, a large-scale compound lens 512 and an image sensor 516 mounted on a PCB 518 (see FIG. 18A, FIG. 18B, and FIG. 18C).

Further, an intermediate image plane 530 is present within multiscale microlens optical detection system 500. For example, intermediate image plane 530 is between microlens array 520 and camera system 510.

From the well-side of intermediate image plane 530, each microlens 522 is used to focus an image of one well 182 onto intermediate image plane 530. For example, if a piece of paper were at the intermediate image plane 530, in image may be projected on the paper. Next, from the camera system-side of intermediate image plane 530, large-scale compound lens 512 (e.g., a larger optic) is focused on the intermediate image plane 530. Accordingly, large-scale compound lens 512 of camera system 510 may be used to image the image at intermediate image plane 530.

An advantage is this multiscale configuration is that each of the microlenses 522 can be high NA and collect a lot of light. Then, use microlenses 522 to magnify the images of each well 182 to the intermediate image plane 530. That is, on the well-side of the microlenses 522 the NA is high, while on the camera system-side the NA is lower. This allows large-scale compound lens 512 to have a low NA. Yet, at the same time, the system as a whole is still able to capture a large amount of light. That is, the presence of microlens array 520 allows more light to be captured than using the large-scale compound lens 512 alone. More details of multiscale microlens optical detection system 500 are shown and described below in FIG. 18A, FIG. 18B, and FIG. 18C.

Referring now to FIG. 18A, FIG. 18B, and FIG. 18C is side views of a portion of multiscale microlens optical detection system 500 shown in FIG. 17 and a process of using same. Further, FIG. 18A, FIG. 18B, and FIG. 18C show an example of camera system 510 including the large-scale compound lens 512 and the image sensor 516 mounted on a PCB 518.

Here, using the addressable light source array 524 that is provided in relation to, for example, 384-well microplate 180, each well 182 may be illuminated with its own LED 526. Accordingly, the detection process uses selective well illumination via the addressable light source array 524 so that there is substantially no sub-image overlap. This allows, for example, multiple wells 182 of 384-well microplate 180 to be imaged and/or processed simultaneously. Therefore, the amount of time that may be needed to perform the optical detection process may be minimized.

In multiscale microlens optical detection system 500, light source array 524 may be used to, for example, selectively illuminate every nth well 182 of 384-well microplate 180. For example, FIG. 18A, FIG. 18B, and FIG. 18C show a portion of one row or one column of 384-well microplate 180 and where every third well 182 may be illuminated and imaged onto intermediate image plane 530. That is because, in this example, each microlens 522 may provide 3× magnification of its corresponding well 182. Accordingly, every third microlens 522 of microlens array 520 and every third LED 526 of light source array 524 may be used to image every third well 182 onto intermediate image plane 530. For example, a sub-image 532 of each well 182 is magnified by its microlens 522 and projected at intermediate image plane 530. In this example, the image of each well 182 is 3× magnified. Because of the 3× magnification, every third well 182 is illuminated to avoid overlap between sub-images 532 of adjacent wells 182. Microlenses 522 are not limited to 3× magnification. This is for example purposes. Other magnification is possible, such as 2× (e.g., every second well illuminated), 3× (e.g., every third well illuminated), 4× (e.g., every fourth well illuminated), 5× (e.g., every fifth well illuminated), and the like.

Then, the large-scale compound lens 512 of camera system 510 relays an intermediate image plane image 534 of multiple sub-images 532 at intermediate image plane 530 onto image sensor 516. Because of the magnification of microlenses 522, a lower pixel count sensor may be utilized as compared to, for example, the image sensor 116 of six read-head optical detection systems 100, 102.

FIG. 18A, FIG. 18B, and FIG. 18C show an example of an image sequence of an optical detection process. For example, FIG. 18A shows one set of every third well 182 illuminated and a one set of sub-images 532 projected at intermediate image plane 530. Also, one intermediate image plane image 534 of this set of sub-images 532 that may be captured using camera system 510.

Next, FIG. 18B shows a next set of every third well 182 illuminated and a next set of sub-images 532 projected at intermediate image plane 530. Also, a next intermediate image plane image 534 of this set of sub-images 532 that may be captured using camera system 510.

Next, FIG. 18C shows a next set of every third well 182 illuminated and a next set of sub-images 532 projected at intermediate image plane 530. Also, a next intermediate image plane image 534 of this set of sub-images 532 that may be captured using camera system 510. This detection process uses selective well illumination so that there is substantially no overlap of sub-images 532. This allows, for example, multiple wells 182 of 384-well microplate 180 to be processed simultaneously, and therefore shortens the optical detection process.

Further, in multiscale microlens optical detection system 500, image capture operations may occur, for example, at a certain portion of 384-well microplate 180 while at substantially the same time certain fluidics operations (using liquid handling system 190) may occur at different portions of 384-well microplate 180 that are not being imaged (FIG. 18A, FIG. 18B, and FIG. 18C). These simultaneous actions in multiscale microlens optical detection system 500 are time-savers with respect to well plate optical detection processes.

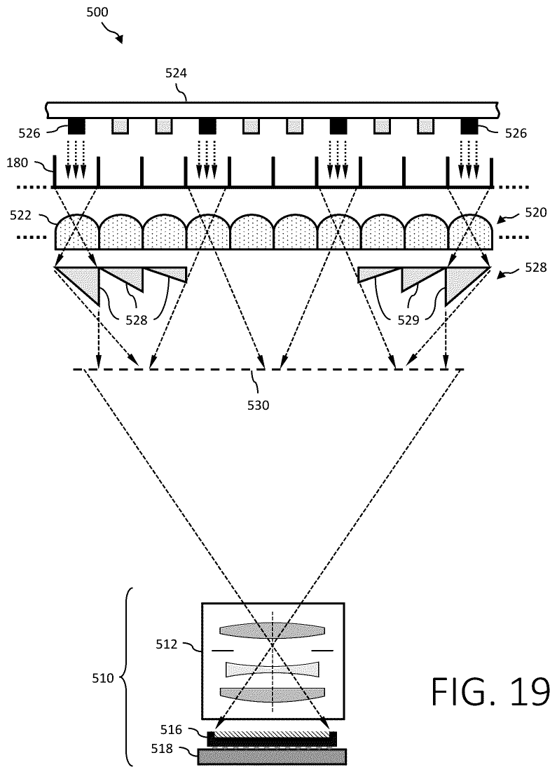

Referring now to FIG. 19 is a side view of another configuration of multiscale microlens optical detection system 500 shown in FIG. 17. In this configuration, multiscale microlens optical detection system 500 may include both the microlens array 520 and a microprism array 528. Microprism array 528 may include an arrangement of microprisms 529.

In this example, microprism array 528 or other micro-optics may be used to reroute the well sub-images 532 from the periphery of the well plate closer to center of intermediate image plane 530. Further, in microprism array 528 the shapes of the microprisms 529 change corresponding to their positions with respect to the well plate. Benefits of this configuration may include (1) it provides the ability to shrink the x-y of intermediate image plane 530, and (2) it reduces the FOV requirements on the large-scale compound lens 512 of camera system 510.

Again, the detection process uses selective well illumination so that there is substantially no overlap of sub-images 532. Again, this allows, for example, multiple wells 182 of 384-well microplate 180 to be processed simultaneously, and therefore shortens the optical detection process.

In of multiscale microlens optical detection system 500 shown in FIG. 17 through FIG. 18C, certain specifications may include-(1) FOV of camera system 510 is every nth well, and (2) large-scale compound lens 512 may have an NA expected ˜0.3. Further, multiscale microlens optical detection system 500 may (1) have higher NA than six read-head optical detection systems 100, 102: (2) be more simple and less costly than six read-head optical detection systems 100, 102: (3) be scalable to full field or step-and-shoot systems; and (4) have multi-color modality that is unlikely to decrease NA or increase lens size.

Generally, multiscale microlens optical detection system 500 shown in FIG. 17 through FIG. 18C may provide certain advantages such as, but not limited to, the following.
(1) Microlenses are high NA but small FOV:
(2) Compound lens can be corrected for large FOV, but small NA
(3) Multiscale-best of both worlds:
(4) Microlenses magnify at the intermediate plane:
   a. NA is automatically lower at the intermediate plane; and
   b. Will match the lower NA of the compound lens without any loss of light collection:

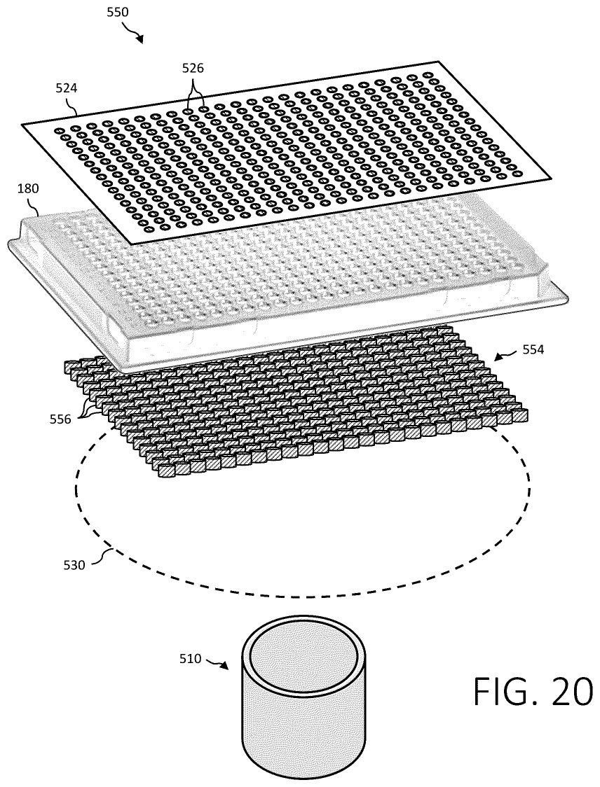

Referring now to FIG. 20 is a perspective view of an example of a multiscale GRIN lens optical detection system 550 in relation to a well plate for processing biological materials, in accordance with an embodiment of the disclosure. Multiscale GRIN lens optical detection system 550 may be substantially the same as multiscale microlens optical detection system 500 shown in FIG. 17 except that microlens array 520 may be replace by a GRIN lens array 554.

GRIN lens array 554 may include one GRIN lens 556 per well of the well plate. For example, if the well plate is the 384-well microplate 180 as shown in FIG. 20, then GRIN lens array 554 may include 384 GRIN lenses 556. Further, the GRIN lenses 556 are arranged to substantially match the well arrangement. Again, for the 384-well microplate 180 as shown in FIG. 20, GRIN lens array 554 may include a 16×24 arrangement of GRIN lenses 556.

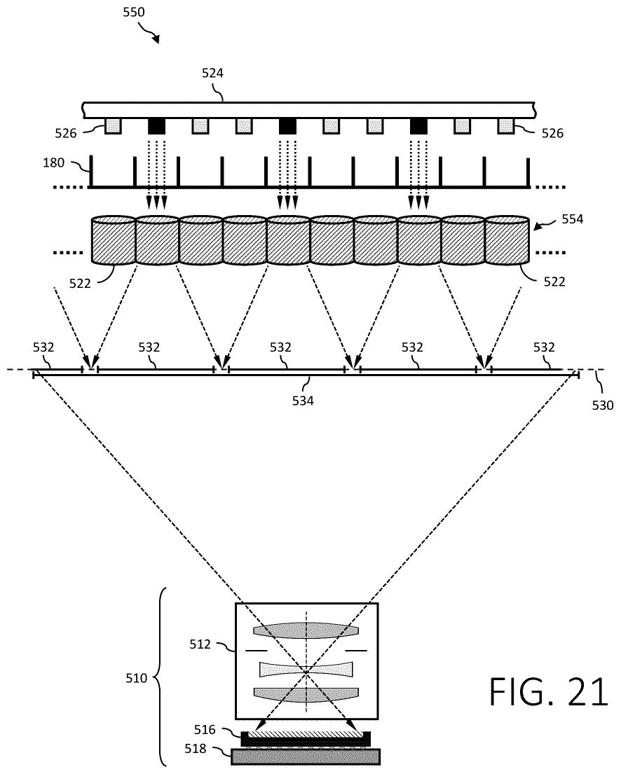

Referring now to FIG. 21 is a side view of a portion of the multiscale GRIN lens optical detection system 550 shown in FIG. 20. Here, substantially the same imaging concept as multiscale microlens optical detection system 500 shown in FIG. 17 may be used. For example, FIG. 21 shows a portion of one row or one column of 384-well microplate 180 and where every third well 182 may be illuminated and imaged onto intermediate image plane 530. This is because, in this example, each GRIN lens 556 may provide 3× magnification of its corresponding well 182. Accordingly, every third GRIN lens 556 of GRIN lens array 554 and every third LED 526 of light source array 524 may be used to image every third well 182 onto intermediate image plane 530. For example, a sub-image 532 of each well 182 is magnified by its GRIN lens 556 and projected at intermediate image plane 530. In this example, the image of each well 182 is 3× magnified. Because of the 3× magnification, every third well 182 is illuminated to avoid overlap between sub-images 532 of adjacent wells 182. GRIN lenses 556 are not limited to 3× magnification. This is for example purposes. Other magnification is possible, such as 2× (e.g., every second well illuminated), 3× (e.g., every third well illuminated), 4× (e.g., every fourth well illuminated), 5× (e.g., every fifth well illuminated), and the like.

In multiscale GRIN lens optical detection system 550 shown in FIG. 20 and FIG. 21, certain specifications may include-(1) FOV of camera system 510 is every nth well, and (2) large-scale compound lens 512 may have an NA expected ˜0.3. Further, GRIN lens optical detection system 550 may (1) have higher NA than six read-head optical detection systems 100, 102: (2) be more simple and less costly than six read-head optical detection systems 100, 102: (3) be scalable to full field or step-and-shoot systems; and (4) have multi-color modality that is unlikely to decrease NA or increase lens size.

Further, in other embodiments, multiscale GRIN lens optical detection system 550 shown in FIG. 20 and FIG. 21 may include the microprism array 528 shown in FIG. 19.

Further, in multiscale GRIN lens optical detection system 550, image capture operations may occur, for example, at a certain portion of 384-well microplate 180 while at substantially the same time certain fluidics operations (using liquid handling system 190) may occur at different portions of 384-well microplate 180 that are not being imaged (FIG. 21). These simultaneous actions in multiscale GRIN lens optical detection system 550 are time-savers with respect to well plate optical detection processes.

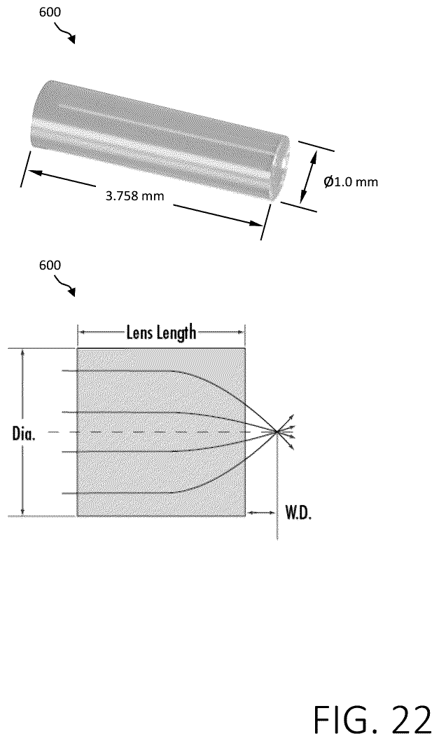

Referring now to FIG. 22 is a perspective view and a side view of an example of a GRIN lens 600 that may be used in the multiscale GRIN lens optical detection system 550 shown in FIG. 20. That is, GRIN lens 600 may be an example of a GRIN lens 556.

In one example, GRIN lens 600 may be the G1P10 series GRIN lens. The G1P10 series GRIN lens is a GRIN lens that is designed for imaging applications. Certain specifications of G1P10 series GRIN lens may include Ø1.0 mm, L=3.758 mm, WD=0.20 mm (Water and Dry), NA=0.5, and uncoated.

Other features of GRIN lens 600 may include (1) GRIN lens: flat glass rod, (2) focusing from gradient in refractive index, (3) small size (up to ˜2 mm), (4) high NA: up to 0.55, and (5) NA decreases with larger FOV.

Referring now to FIG. 20, FIG. 21, and FIG. 22, compared with multiscale microlens optical detection system 500 shown in FIG. 17, multiscale GRIN lens optical detection system 550 may provide certain advantages. For example, GRIN lenses may provide certain advantages, such as, but not limited to, the following.
(1) Much higher imaging quality than microlens:
   a. High NA and large FOV:
   b. NA lower with larger FOV, but 0.3-0.4 NA expected:
(2) Aspheric index profile=aspheric lens (this is standard);
(3) One GRIN lens per well, no compound microlenses per well:
(4) Higher QC than microlens array:
(5) GRIN lens length can be adjusted during fabrication to compensate for difference in index profile from expected:
(6) GRIN face can be polished at angle, essentially making it a lens plus prism:
(7) Highly scalable:
(8) Can create a sub-region read-head for 4×4 or 8×8 wells of 384-well microplate:
   a. $1 k-5 k for GRIN lenses:
   b. Can step through the 6-24 subregions:
(9) Step-and-shoot alignment:
   a. Illuminate with IR LEDs (farther red than fluorescent emission); and
   b. Align to images of well bottoms.

In some embodiments, the multiscale optical detection system, described elsewhere herein, may comprise a high resolution microlens optical detection system 560 (FIG. 28) and/or a high resolution GRIN lens optical detection system 562 (FIG. 27). In some cases, the high resolution microlens optical detection system 560 and/or the high resolution GRIN lens optical detection system 562 may image, capture signals, and/or generate an image of a well 180 of a multi-well plate 182, described elsewhere herein. The high resolution microlens optical detection system 560 and/or the high resolution GRIN lens optical detection system 562 may image one or more wells 180 of a multi-well pate 182. The high resolution microlens optical detection system 560 and/or the high resolution GRIN lens optical detection system 562 may image emitted light from one or more biological materials positioned at a distance of at or less than the diffraction limit of light emitted by the one or more biological materials adjacent to or disposed on a surface of the well 180. In some cases, at least two biological materials of the one or more biological materials may be imaged when the at least two biological materials are adjacent and/or disposed on a surface of well 180 at a center-to-center distance less than about the diffraction limit of light emitted from a first or a second biological material of the at least two biological materials. The microlens array 520 and/or the GRIN lens array 554 of the high resolution microlens optical detection system 560 and the high resolution GRIN lens optical detection system 562, respectively, enable the detection of light emitted from biological materials positioned at or less than the diffraction of light emitted by the first biological material or the second biological material. The microlens array and/or the GRIN lens array provide high resolution imaging capabilities by generating one or more intermediate imaging planes (e.g., 532) of the relayed emission light of the biological materials illuminated by the one or more LEDs 526 of the light source arrays 524. The intermediate overlapping imaging planes imaged onto the imaging sensor 516 by the large scale compound lens 512 of the camera system 510 are then resolved on the imaging sensor 516. Without the use of the microlens array 520 and/or the GRIN lens array 554, the emission of light from the at least two biological materials positioned at a distance less than the diffraction limit of light emitted by a first or a second biological material of the at least two biological materials may diffuse with poor to no correlation of the corresponding region of the biological sample projected to the intermediate imaging plate 530. With such a diffuse image, no accurate image, signal, and/or representation of the densely packed biological materials on and/or adjacent to the well surface may be determined by the image sensor. The parameters of the one or more lenses 522 of the microlens array 520 and/or of the GRIN lens array 554 e.g., center-to-center spacing 536, diameter, working distance, focal length, length of the lens, numerical aperture, refractive index gradient, pitch, or any combination thereof, provide super and/or high resolution imaging performance of the optical detection systems enabling the identification of biological materials in high density colonies, arrays, and/or agglomerates of biological materials. In some cases, the center-to-center spacing 536 may comprise a distance of at least about 100 nanometers (nm). In some cases, the center-to-center spacing 536 may comprise less than about 500 nm.

In some embodiments, the high resolution microlens optical detection system 560 (FIG. 28) may comprise: a camera system 510, micro lens element 520, one or more light sources 526 (e.g., one or more LEDs). In some cases, the one or more light sources 526, as described elsewhere herein, may form a light source array 524. The microlens optical detection system 560 may be positioned over and/or under a well 180 of a multi-well plate. In some embodiments, the one or more light sources 526 of the light source array 524 may be positioned above the well 180 of the multi-well plate 182. Each well 180 of the multi-well plate may have one or more light sources 526 configured to illuminate a surface of the well or a portion thereof. In some cases, one or more biological materials, described elsewhere herein, may be disposed of adjacent to and/or disposed on the surface of the well. The one or more biological materials adjacent to and/or disposed on the surface when provided an emission light of the one or more light sources may emit light 570 (e.g., fluorescence, phosphorescence, bioluminescence, etc.) of one or more central wavelengths and/or bandwidths. The emitted light 570 of the one or more biological materials may be coupled into the microlens array 520. The microlens array 520 may couple the light emitted from the one or more biological materials to one or more intermediate imaging planes 532 of an imaging plane 530 of the camera system 510. The one or more intermediate imaging planes 532 comprised of the emitted light of the one or more biological materials may be optically coupled and imaged on the imaging sensor 516 through the large scale compound lens 512 to such that the imaging sensor 516 may collect, acquire, and/or detect photons of the emitted light 570 of the biological material(s). The imaging sensor 516 may be electrically coupled to a PCB 518, as described elsewhere herein, that may transmit and/or provide the corresponding electrical signal to other aspects of the optical detection system to produce one or more images of a surface of the well (e.g., of the one or more biological materials disposed adjacent or on a surface of the well).

In some embodiments, the high resolution GRIN lens optical detection system 562 (FIG. 27) may comprise: a camera system 510, GRIN lens element 554, one or more light sources 526 (e.g., one or more LEDs). In some cases, the one or more light sources 526, as described elsewhere herein, may form a light source array 524. The GRIN lens optical detection system 562 may be positioned over and/or under a well 180 of a multi-well plate. In some embodiments, the one or more light sources 526 of the light source array 524 may be positioned above the well 180 of the multi-well plate 182. Each well 180 of the multi-well plate may have one or more light sources 526 configured to illuminate a surface of the well or a portion thereof. In some cases, one or more biological materials, described elsewhere herein, may be disposed of adjacent to and/or disposed on the surface of the well. The one or more biological materials adjacent to and/or disposed on the surface when provided an emission light of the one or more light sources may emit light 570 (e.g., fluorescence, phosphorescence, bioluminescence, etc.) of one or more central wavelengths and/or bandwidths. The emitted light 570 of the one or more biological materials may be coupled into the microlens array 520. The microlens array 520 may couple the light emitted from the one or more biological materials to one or more intermediate imaging planes 532 of an imaging plane 530 of the camera system 510. The one or more intermediate imaging planes 532 comprised of the emitted light of the one or more biological materials may be optically coupled and imaged on the imaging sensor 516 through a large scale compound lens 512 such that the imaging sensor 516 may collect, acquire, and/or detect photons of the emitted light 570 of the biological material(s). The imaging sensor 516 may be electrically coupled to a PCB 518, as described elsewhere herein, that may transmit and/or provide the corresponding electrical signal to other aspects of the optical detection system to produce one or more images of a surface of the well (e.g., of the one or more biological materials disposed adjacent or on a surface of the well).

### Fluidics System Including Multiscale Optical Detection

Referring now to FIG. 23 is a block diagram of an example of a fluidics system 700 that may be based on the optical detection configurations and/or systems shown in FIG. 1 through FIG. 22. Fluidics system 700 may further include event-based detection.

Generally, fluidics system 700 may be any optical measurement system that can be used to accurately determine the presence or absence of a defined analyte and/or target component in different materials and to sensitively quantify the amount of analyte and/or target components present in a sample. In this example, fluidics system 700 may include well plate 180, liquid handling system 190, and any one or more of the multiscale optical detection systems 100, 102, 400, 402, 500, 550. Fluidics system 700 may also include a controller 710. Controller 710 may further include an image processing module 712 and digital images 714 generated by any of the multiscale optical detection systems 100, 102, 400, 402, 500, 550.

In fluidics system 700, liquid handling system 190 may be provided in relation to well plate 180. Again, liquid handling system 190 may be, for example, an automated liquid handling system. In this example, any one or more of the multiscale optical detection systems 100, 102, 400, 402, 500, 550 may be provided beneath well plate 180, while liquid handling system 190 may be provided above well plate 180. Again, well plate 180 may be any standard glass or plastic well plate used for processing biological materials and that is substantially transparent to light. Well plate 180 may be, for example, a standard 6-well, 12-well, 24-well, 48-well, 96-well, 384-well, or 1536-well microplate. The 384-well microplate 180 shown in FIG. 1 through FIG. 2C is a specific example of well plate 180.

Controller 710 may be electrically connected to liquid handling system 190 and the multiscale optical detection systems 100, 102, 400, 402, 500, 550. Controller 710 may, for example, be a general-purpose computer, special purpose computer, personal computer, microprocessor, or other programmable data processing apparatus. Controller 710 may provide processing capabilities, such as storing, interpreting, and/or executing software instructions, as well as controlling the overall operations of fluidics system 700. The software instructions may include machine readable code stored in non-transitory memory that is accessible by controller 710 for the execution of the instructions. Controller 710 may be configured and programmed to control data and/or power aspects of fluidics system 700. Further, data storage (not shown) may be built into or provided separate from controller 710.

Multiscale optical detection systems 100, 102, 400, 402, 500, 550 may be used to obtain light intensity readings. In the presently disclosed optical detection configurations and/or systems shown in FIG. 1 through FIG. 22, the multiscale optical detection systems 100, 102, 400, 402, 500, 550 may include optical sensors, such as image sensors 116, 416, 516 (e.g., charge coupled devices, photodetectors, spectrometers, photodiode arrays, or any combinations thereof). Further, other optical components (e.g., optical lenses, optical filters, mirrors, prisms, polarizers, gratings, and the like) may be associated with the multiscale optical detection systems 100, 102, 400, 402, 500, 550 for collecting and/or directing light. Further, image processing module 712 at controller 710 may be used to process any information, such as digital images 714, from multiscale optical detection systems 100, 102, 400, 402, 500, 550.

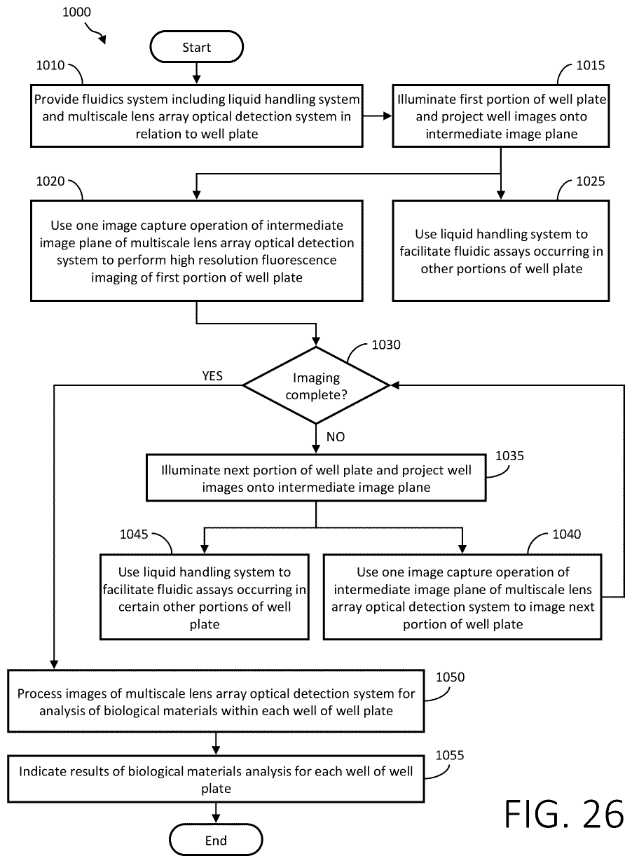

In fluidics system 700, any one of the multiscale optical detection systems 100, 102, 400, 402, 500, 550 may be used to perform optical detection operations with respect to well plate 180. More details of examples of optical detection methods are shown and described below in FIG. 24, FIG. 25, and FIG. 26.

### Optical Detection Methods

Referring now to FIG. 24 is a flow diagram of an example of a method 800 of using fluidics system 700 shown in FIG. 23 that includes a multiple read-head optical detection system. In one example of method 800, fluidics system 700 may include any of the configurations of six read-head optical detection system 100 shown in FIG. 1 through FIG. 7. In another example of method 800, fluidics system 700 may include any of the configurations of six read-head optical detection system 102 shown in FIG. 8 through FIG. 12.

Further, by way of example, the steps of method 800 are described below with respect to using six read-head optical detection system 100 of FIG. 1 through FIG. 7. However, the method steps are equally applicable to using six read-head optical detection system 102 of FIG. 8 through FIG. 12. Method 800 may include, but is not limited to, the following steps.

At a step 810, a fluidics system is provided that includes a liquid handling system and a six read-head optical detection system in relation to a well plate. In one example, fluidics system 700 of FIG. 23 may be provided that includes liquid handling system 190 and six read-head optical detection system 100 of FIG. 1 through FIG. 7. Both provided in relation to well plate 180, such as 384-well microplate 180, as shown, for example, in FIG. 1. However, in other embodiments, fluidics system 700 of FIG. 23 may be provided that includes six read-head optical detection system 102 of FIG. 8 through FIG. 12.

At a step 815, the liquid handling system is used to facilitate fluidic assays that occur in the wells of the well plate. For example, and referring to FIG. 1 through FIG. 7, liquid handling system 190 (e.g., an automated liquid handling system) may be used to facilitate fluidic assays (e.g., certain chemistry) that occur, for example, in the respective wells 182 of 384-well microplate 180.

At a step 820, one image capture operation of the six read-head optical detection system may be used to perform high resolution fluorescence imaging of all the wells of the well plate. For example, one image capture operation of six read-head optical detection system 100 of FIG. 1 through FIG. 7 may be used to perform high resolution fluorescence imaging of all wells 182 of 384-well microplate 180.

More specifically, at substantially the same time, an image capture event occurs at each of the six read-heads (e.g., at each of camera systems 110a, 110b, 110c, 110d, 110e, and 110f) of six read-head optical detection system 100. The image capture events include activating the light sources 120. Then, and referring now fluidics system 700 of FIG. 23, six digital images 714 are generated and saved. Together, the six digital images 714 provide imaging of substantially the entirety of, for example, 384-well microplate 180. That is, the six digital images 714 may provide high resolution fluorescence imaging of, for example, all the wells 182 of 384-well microplate 180.

At a step 825, the digital images of the six read-head optical detection system are processed and used for analysis of biological materials within each well of the well plate. For example, six digital images 714 from camera systems 110a, 110b, 110c, 110d, 110e, and 110f, respectively, of six read-head optical detection system 100 may be processed and used for analysis of biological materials within, for example, each well 182 of 384-well microplate 180. For example, certain pixels of each of the six digital images 714 may be mapped to a specific well 182 of 384-well microplate 180. Then, each pixel group may be processed with respect to determining the contents of its corresponding well 182. In one example, controller 710 and/or image processing module 712 of fluidics system 700 may be used to perform the image processing operations.

At a step 830, the results of the biological materials analysis for each well of well plate is indicated. For example, the results of the biological materials analysis for each well 182 of 384-well microplate 180 may be indicated or otherwise reported to any interested party or entity. In one example, controller 710 and/or image processing module 712 of fluidics system 700 may be used to indicate the results.

Referring now to FIG. 25 is a flow diagram of an example of a method 900 of using fluidics system 700 shown in FIG. 23 that includes a step-and-shoot optical detection system. In one example of method 900, fluidics system 700 may include the 6-step step-and-shoot optical detection system 400 shown in FIG. 13 through FIG. 14C. In another example of method 900, fluidics system 700 may include the 24-step step-and-shoot optical detection system 402 shown in FIG. 15 through FIG. 16C.

Further, by way of example, the steps of method 900 are described below with respect to using the 6-step step-and-shoot optical detection system 400 shown in FIG. 13 through FIG. 14C. However, the method steps are equally applicable to using the 24-step step-and-shoot optical detection system 402 shown in FIG. 15 through FIG. 16C. Method 900 may include, but is not limited to, the following steps.

At a step 910, a fluidics system is provided that includes a liquid handling system and a step-and-shoot optical detection system in relation to a well plate. In one example, fluidics system 700 of FIG. 23 may be provided that includes liquid handling system 190 and the 6-step step-and-shoot optical detection system 400 shown in FIG. 13 through FIG. 14C. Both provided in relation to well plate 180, such as 384-well microplate 180, as shown, for example, in FIG. 13. However, in other embodiments, fluidics system 700 of FIG. 23 may be provided that includes the 24-step step-and-shoot optical detection system 402 shown in FIG. 15 through FIG. 16C. Method 900 may proceed to both steps 915 and 920.

At a step 915 and running concurrently to step 920, one image capture operation of the step-and-shoot optical detection system may be used to perform high resolution fluorescence imaging of a first portion of the well plate. For example, one image capture operation of the 6-step step-and-shoot optical detection system 400 shown in FIG. 13 through FIG. 14C may be used to perform high resolution fluorescence imaging of a first portion of 384-well microplate 180.

More specifically, linear translator 424 may be used to position camera system 410 at, for example, one of the six plate segments 484 of 384-well microplate 180 (see FIG. 14B and FIG. 14C). Then, one image capture operation of the 6-step step-and-shoot optical detection system 400 may be used to perform high resolution fluorescence imaging of this one plate segment 484 of 384-well microplate 180 (see FIG. 14B and FIG. 14C). A corresponding digital image 714 of the selected plate segment 484 may be generated and stored. The image capture event includes activating the light source 420.

Further, image capture operations may occur at a certain plate segment 484 of 384-well microplate 180 while at substantially the same time certain fluidics operations (step 920) may occur at a different plate segment 484 of 384-well microplate 180 (see FIG. 14B and FIG. 14C). Method 900 may proceed to step 925.

At a step 920 and running concurrently to step 915, the liquid handling system is used to facilitate fluidic assays that occur in certain other wells of the well plate. For example, liquid handling system 190 (e.g., an automated liquid handling system) may be used to facilitate fluidic assays (e.g., certain chemistry) that occur, for example, in certain plate segments 484 of 384-well microplate 180 other than those being imaged (see FIG. 14B and FIG. 14C).

Further, fluidics operations may occur at a certain plate segment 484 of 384-well microplate 180 while at substantially the same time certain image capture operations (step 915) may occur at a different plate segment 484 of 384-well microplate 180 (see FIG. 14B and FIG. 14C).

At a decision step 925, it is determined whether imaging is completed at all portions of the well plate. For example, it may be determined whether imaging is completed as all plate segments 484 of 384-well microplate 180 (see FIG. 14B and FIG. 14C). If imaging is not completed at all portions of the well plate, then method 900 proceeds to step 930. If imaging is completed at all portions of the well plate, then method 900 may proceed to step 945.

At a step 930, the read-head is stepped to the next portion of the well plate. For example, and referring to FIG. 13, using linear translator 424, the camera system 410 (e.g., the read-head) of the 6-step step-and-shoot optical detection system 400 is stepped to the next one of six plate segments 484 of 384-well microplate 180. Method 900 may proceed to both steps 935 and 940.

At a step 935 and running concurrently to step 940, one image capture operation of the step-and-shoot optical detection system may be used to perform high resolution fluorescence imaging of a next portion of the well plate. For example, one image capture operation of the 6-step step-and-shoot optical detection system 400 shown in FIG. 13 through FIG. 14C may be used to perform high resolution fluorescence imaging at the selected plate segment 484 of 384-well microplate 180. A corresponding digital image 714 of the selected plate segment 484 may be generated and stored.

Further, image capture operations may occur at the selected plate segment 484 of 384-well microplate 180 while at substantially the same time certain fluidics operations (step 940) may occur at a different plate segment 484 of 384-well microplate 180 (see FIG. 14B and FIG. 14C). The image capture event includes activating the light source 420. Method 900 may return to step 925.

At a step 940 and running concurrently to step 935, the liquid handling system is used to facilitate fluidic assays that occur in certain other portions of the well plate. For example, liquid handling system 190 (e.g., an automated liquid handling system) may be used to facilitate fluidic assays (e.g., certain chemistry) that occur, for example, in certain plate segments 484 of 384-well microplate 180 other than those being imaged (see FIG. 14B and FIG. 14C). That is, fluidics operations may occur at a certain plate segment 484 of 384-well microplate 180 while at substantially the same time certain image capture operations (step 935) may occur at different plate segments 484 of 384-well microplate 180 (see FIG. 14B and FIG. 14C).

At a step 945, the digital images of the step-and-shoot optical detection system are processed and used for analysis of biological materials within each well of the well plate. For example, the six digital images 714 from the six steps of camera system 410 of 6-step step-and-shoot optical detection system 400 may be processed and used for analysis of biological materials within, for example, each well 182 of 384-well microplate 180. For example, certain pixels of each of the six digital images 714 may be mapped to a specific well 182 of 384-well microplate 180. Then, each pixel group may be processed with respect to determining the contents of its corresponding well 182. In one example, controller 710 and/or image processing module 712 of fluidics system 700 may be used to perform the image processing operations. Method 900 may proceed to step 950.

At a step 950, the results of the biological materials analysis for each well of well plate is indicated. For example, the results of the biological materials analysis for each well 182 of 384-well microplate 180 may be indicated or otherwise reported to any interested party or entity. In one example, controller 710 and/or image processing module 712 of fluidics system 700 may be used to indicate the results. Method 900 ends.

Referring now to FIG. 26 is a flow diagram of an example of a method 1000 of using fluidics system 700 shown in FIG. 23 that includes a lens array optical detection system. In one example of method 1000, fluidics system 700 may include the multiscale microlens optical detection system 500 shown in FIG. 17 through FIG. 19. In another example of method 1000, fluidics system 700 may include the multiscale GRIN lens optical detection system 550 shown in FIG. 20, FIG. 21, and FIG. 22.

Further, by way of example, the steps of method 1000 are described below with respect to using the multiscale microlens optical detection system 500 shown in FIG. 17 through FIG. 19. However, the method steps are equally applicable to using the multiscale GRIN lens optical detection system 550 shown in FIG. 20, FIG. 21, and FIG. 22. Method 1000 may include, but is not limited to, the following steps. Method 1000 may include, but is not limited to, the following steps.

At a step 1010, a fluidics system is provided that includes a liquid handling system and a multiscale lens array optical detection system in relation to a well plate. In one example, fluidics system 700 of FIG. 23 may be provided that includes liquid handling system 190 and the multiscale microlens optical detection system 500 shown in FIG. 17 through FIG. 19. Both provided in relation to well plate 180, such as 384-well microplate 180, as shown, for example, in FIG. 17. However, in other embodiments, fluidics system 700 of FIG. 23 may be provided that includes the multiscale GRIN lens optical detection system 550 shown in FIG. 20, FIG. 21, and FIG. 22. Method 1000 may proceed to step 1015.

At a step 1015, a first portion of the well plate is illuminated and as a result images of individual wells are projected onto an intermediate image plane of the lens array optical detection system. For example, and referring now to FIG. 18A, FIG. 18B, and FIG. 18C, certain LEDs 526 of light source array 524 of multiscale microlens optical detection system 500 may be activated. For example, FIG. 18A shows an example of a first set of every third LED 526 of light source array 524 that may be activated. As a result, sub-images 532 of individual wells 182 that correspond to the activated LEDs 526 may be projected onto intermediate image plane 530 of multiscale microlens optical detection system 500. Further, adjacent sub-images 532 may be substantially not overlapping. Method 1000 may proceed to both steps 1020 and 1025.

At a step 1020 and running concurrently to step 1025, one image capture operation of the intermediate image plane of the multiscale lens array optical detection system may be used to perform high resolution fluorescence imaging of a first portion of the well plate. For example, and referring now to FIG. 18A, FIG. 18B, and FIG. 18C, camera system 510 may be used to capture a first image of the intermediate image plane 530 of the multiscale microlens optical detection system 500. Then, the resulting intermediate image plane image 534 may be used to perform high resolution fluorescence imaging of a first portion of 384-well microplate 180.

Further, in this step, image capture operations may occur at a certain portion of 384-well microplate 180 while at substantially the same time certain fluidics operations (step 1025) may occur at different portions of 384-well microplate 180 (FIG. 18A, FIG. 18B, and FIG. 18C). Method 1000 may proceed to step 1030.

At a step 1025 and running concurrently to step 1020, the liquid handling system is used to facilitate fluidic assays that occur in certain other portions of the well plate. For example, liquid handling system 190 (e.g., an automated liquid handling system) may be used to facilitate fluidic assays (e.g., certain chemistry) that occur, for example, in certain portions of 384-well microplate 180 other than those being imaged (see FIG. 18A, FIG. 18B, and FIG. 18C). That is, fluidics operations may occur at certain portions of 384-well microplate 180 while at substantially the same time certain image capture operations (step 1020) may occur at different portions of 384-well microplate 180 (see FIG. 18A, FIG. 18B, and FIG. 18C).

At a decision step 1030, it is determined whether imaging is completed at all portions of the well plate. For example, it may be determined whether imaging is completed as all portions of 384-well microplate 180 (see FIG. 18A, FIG. 18B, and FIG. 18C). This may be based, for example, on imaging the multiple sets of every third well 182 of 384-well microplate 180 being illuminated using the individually controlled LEDs 526 of light source array 524. If imaging is not completed at all portions of the well plate, then method 1000 proceeds to step 1035. If imaging is completed at all portions of the well plate, then method 1000 may proceed to step 1050.

At a step 1035, a next portion of the well plate is illuminated and as a result images of individual wells are projected onto an intermediate image plane of the lens array optical detection system. For example, and referring now to FIG. 18A, FIG. 18B, and FIG. 18C, certain LEDs 526 of light source array 524 of multiscale microlens optical detection system 500 may be activated. For example, FIG. 18B and FIG. 18C show an example of a next set of every third LED 526 of light source array 524 that may be activated. As a result, sub-images 532 of individual wells 182 that correspond to the activated LEDs 526 may be projected onto intermediate image plane 530 of multiscale microlens optical detection system 500. Further, adjacent sub-images 532 may be substantially not overlapping. Method 1000 may proceed to both steps 1040 and 1045.

At a step 1040 and running concurrently to step 1045, one image capture operation of the intermediate image plane of the multiscale lens array optical detection system may be used to perform high resolution fluorescence imaging of a next portion of the well plate. For example, and referring now to FIG. 18A, FIG. 18B, and FIG. 18C, camera system 510 may be used to capture a next image of the intermediate image plane 530 of the multiscale microlens optical detection system 500. Then, the resulting intermediate image plane image 534 may be used to perform high resolution fluorescence imaging of the next portion of 384-well microplate 180.

Further, in this step, image capture operations may occur at a certain portion of 384-well microplate 180 while at substantially the same time certain fluidics operations (step 1025) may occur at different portions of 384-well microplate 180 (FIG. 18A, FIG. 18B, and FIG. 18C). Method 1000 may return to step 1030.

At a step 1045 and running concurrently to step 1040, the liquid handling system is used to facilitate fluidic assays that occur in certain other portions of the well plate. For example, liquid handling system 190 (e.g., an automated liquid handling system) may be used to facilitate fluidic assays (e.g., certain chemistry) that occur, for example, in certain portions of 384-well microplate 180 other than those being imaged (see FIG. 18A, FIG. 18B, and FIG. 18C). That is, fluidics operations may occur at certain portions of 384-well microplate 180 while at substantially the same time certain image capture operations (step 1040) may occur at different portions of 384-well microplate 180 (see FIG. 18A, FIG. 18B, and FIG. 18C).

At a step 1050, the digital images of the multiscale lens array optical detection system are processed and used for analysis of biological materials within each well of the well plate. For example, the multiple intermediate image plane images 534, which are images of the multiple sets of every third well 182 of 384-well microplate 180 being illuminated, may be processed, and used for analysis of biological materials within, for example, each well 182 of 384-well microplate 180. For example, certain pixels of each of the intermediate image plane images 534 may be mapped to a specific well 182 of 384-well microplate 180. Then, each pixel group may be processed with respect to determining the contents of its corresponding well 182. In one example, controller 710 and/or image processing module 712 of fluidics system 700 may be used to perform the image processing operations. Method 1000 may proceed to step 1055.

At a step 1055, the results of the biological materials analysis for each well of well plate is indicated. For example, the results of the biological materials analysis for each well 182 of 384-well microplate 180 may be indicated or otherwise reported to any interested party or entity. In one example, controller 710 and/or image processing module 712 of fluidics system 700 may be used to indicate the results. Method 1000 ends.

### Event-Based Optical Detection

In another example, any of the multiscale optical detection systems 100, 102, 400, 402, 500, 550 of fluidics system 700 shown in FIG. 18 may include an event-based sensor 720. In this example, fluidics system 700 may be an event-based fluidics system 700. In one example, event-based sensor 720 may be the Metavision® event-based sensor available from Prophesee (Paris, France). In the Metavision® event-based sensor, each pixel may intelligently activate itself depending on the contrast change (movement) it detects.

Because event-based fluidics system 700 may be used for processing biological materials in well plates, event-based sensor 720 may be useful for event-based optical detection with respect to processing and/or assaying biological materials.

For example, image sensors 116 of six read-head optical detection systems 100 and 102 may be event-based sensors 720. Image sensors 416 of the 6-step step-and-shoot optical detection system 400 and/or of the 24-step step-and-shoot optical detection system 402 may be event-based sensors 720. Image sensors 516 of multiscale microlens optical detection system 500 and/or multiscale GRIN lens optical detection system 550 may be event-based sensors 720.

Any assay that uses light in a detection process may benefit from event-based vision. For example, event-based optical detection may be used in a fluorescence-based assay where incorporation of a fluorescently labeled molecule or “tag” is monitored. In another example, event-based optical detection may be used in an assay where an enzymatic reaction is used to generate light in response to a detection event (e.g., a fluorescent assay or a luminescent assay). In yet another example, event-based optical detection may be used in a colorimetric assay where the change of color can be registered as a change in intensity per pixel.

In one example, event-based optical detection may be used in a nucleic acid assay for analysis of one or more target nucleic acid sequences in a sample. Further, event-based optical detection may be extended to sequencing-by-synthesis (SBS) sequencing where incorporation of a fluorescently labeled nucleotide or enzymatic generation of light (e.g., pyrosequencing) are used.

In another example, event-based optical detection may be used in an immunodetection assay for analysis of one or more target analytes in a sample. For example, event-based optical detection may be extended to immunodetection of one or more target proteins in a sample. An immunodetection assay may, for example, be a colorimetric assay or non-colorimetric assay (e.g., a fluorescent assay or a luminescent assay).

In yet another example, event-based optical detection may be used in a multiomic assay that combines, for example, the detection of nucleic acid targets and protein targets in a single assay.

Event-based optical detection may be used for fluorescence lifetime imaging. For example, an analyte may be excited with a very short pulse of light (e.g., on the order of about 10\hat{ }-15 s to 10\hat{ }-9 s) and the pixels of the camera may detect counts in time bins after the pulse. An advantage of this approach is that fluorescence lifetime can be used to distinguish between analytes and because the signal is generated from pixels independently, they can be distinguished in real time thus enabling a real time process.

Accordingly, in event-based fluidics system 700 for processing and/or assaying biological materials, examples of “events” that may be detected using event-based sensor 720 may include, but are not limited to, the following.
(1) Incorporation of a fluorescently labeled molecule and detection of change of signal, without removal of previous fluorescence:
(2) Detection of a signal generated by an enzymatic reaction emitted during a detection event such as in a pyrosequencing reaction or an immunodetection reaction; and
(3) Detection of fluorescent labels by measuring fluorescence lifetime.

Further, event-based optical detection using, for example, event-based sensor 720 may be useful in other ways with respect to systems for processing and/or assaying biological materials, such as, but not limited to, the following.
(1) Monitoring process steps (e.g., quality control) such as filling of the wells in the multi-well plate:
(2) Antibody-antigen binding reaction that uses a fluorescent or other light-based readout; and
(3) Combining multi-analyte readout in a single platform.

Accordingly, in some embodiments, the disclosure provides an event-based optical detection system (e.g., event-based fluidics system 700) that uses an event-based sensor (e.g., event-based sensor 720) in a system for processing and/or assaying biological materials.

In summary and referring now again to FIG. 1 through FIG. 26, the multiscale optical detection systems 100, 102, 400, 402, 500, and 550 and methods 800, 900, and 1000 for imaging well plates provide mechanisms by which multiple wells of the well plate may be imaged and/or processed simultaneously in the optical detection process. Accordingly, the multiscale optical detection systems 100, 102, 400, 402, 500, and 550 and methods 800, 900, and 1000 for imaging well plates may be used to reduce the amount of time that may be needed to perform the optical detection process as compared with existing optical detection systems and methods.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the disclosure.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the disclosure will be apparent to the skilled person without departing from the scope and spirit of the disclosure. Although the subject matter has been disclosed in connection with specific preferred aspects or embodiments, it should be understood that the subject matter as claimed should not be unduly limited to such specific aspects or embodiments.

The subject matter may be implemented using hardware, software, or a combination thereof and may be implemented in one or more computer systems or other processing systems. In one aspect, the subject matter is directed toward one or more computer systems capable of carrying out the functionality described herein.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other existing factors depending on the desired properties sought to be obtained by the subject matter. For example, the term “about,” when referring to a value can be meant to encompass variations of, in some embodiments±100%, in some embodiments±50%, in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A system configured to image a surface, comprising:
(a) a first light source and a second light source configured to illuminate a first surface of a well, wherein the first light source and the second light source are separated at a distance of less than about 500 nanometers:
(b) an optical element configured to couple emitted light of the first light source and the second light source from a second surface of the well, wherein the second surface of the well is axially separated from the first surface of the well along an optical axis parallel to an optical axis of the first light source or an optical axis of the second light source, and wherein the optical element comprises a plurality of lens elements; and
(c) a detector optically coupled to the optical element, wherein the detector is configured to detect the light emitted from the second surface of the well.

2. The system of claim 1, wherein the optical element comprises a polygonal optical element optically coupled to a surface of at least a lens element of the plurality of lens elements.

3. The system of claim 1, wherein the first light source, the second light source, or a combination thereof, comprise a light emitting diode, and wherein the light emitting diode comprises a plurality of light emitting diodes.

4. The system of claim 1, wherein the well comprises a well of a multi-well plate, and wherein the detector comprises a plurality of detectors, wherein a first detector of the plurality of detectors is configured to detect emitted light from a first well of the multi-well plate, and a second detector of the plurality of detectors is configured to detect emitted light from a second well of the multi-well plate.

5. The system of claim 4, wherein the first well and the second well are non-adjacent wells of the multi-well plate.

6. The system of claim 1, wherein the first light source emits a first wavelength of light, and the second light source emits a second wavelength of light, wherein the first wavelength of light and the second wavelength of light differ.

7. The system of claim 1, wherein the detector comprises a two-dimensional sensor, a charge coupled device sensor, a complementary metal oxide semiconductor sensor, an event based sensor, or a combination thereof.

8. The system of claim 1, wherein the first surface of the well comprises a biological material.

9. A method for detecting a biological material on a surface, comprising:
a. illuminating the biological material on a first surface of a well with a first light source and a second light source, wherein the first light source and the second light source are separated at a distance of less than about 500 nanometers; and
b. detecting an emission signal from the biological material through an optical element coupled to a detector, thereby detecting the biological material on the first surface of the well, wherein the emission signal is detected from a second surface of the well axially separated from the first surface of the well along an optical axis parallel to an optical axis of the first light source or an optical axis parallel to an optical axis of the second light source, and wherein the optical element comprises a plurality of lens elements.

10. The method of claim 9, wherein the well comprises a well of a multi-well plate.

11. The method of claim 10, wherein the detector comprises a plurality of detectors, wherein a first detector of the plurality of detectors is configured to detect an emission signal from a first well of the multi-well plate, and a second detector of the plurality of detectors is configured to detect an emission signal from a second well of the multi-well plate, and wherein the first well and the second well are non-adjacent wells of the multi-well plate.

12. The method of claim 9, wherein the detector comprises a two-dimensional sensor, a charge coupled device sensor, a complementary metal oxide semiconductor sensor, an event based sensor, or a combination thereof.

13. The method of claim 12, wherein a pixel of a plurality of pixels of the event based sensor activates to detect the emission signal when a change in the emission signal is detected.

14. The method of claim 10, further comprising translating the detector, the first light source, the second light source, the optical element, or a combination thereof, along an axis of the multi-well plate and repeating (a) and (b).

15. The method of claim 9, wherein the optical element further comprises a polygonal optical element coupled to a surface of at least a lens element of the plurality of lens elements.

16. The method of claim 9, wherein the first light source, the second light source, or a combination thereof, comprises a light emitting diode.

17. The method of claim 16, wherein the light emitting diode comprises a plurality of light emitting diodes.

18. The method of claim 16, wherein the light emitting diode comprises an array of light emitting diodes.

19. The method of claim 9, wherein the first light source emits a first wavelength of light, and the second light source emits a second wavelength of light, and wherein the first wavelength of light and the second wavelength of light differ.

20. The method of claim 9, wherein the biological material comprises a nucleic acid, a protein, or both.
